(19) United States
(12) Patent Application Publication
(10) Pub. No.: US 2009/0077169 A1
(43) Pub. Date: Mar. 19, 2009

(54) NETWORK DEVICE, SERVICE PROVIDING METHOD, AND SERVICE PROVIDING PROGRAM

(75) Inventors: Ryuichi Ikeura, Kanagawa (JP); Takehito Kuroko, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD, TOKYO (JP)

(21) Appl. No.: 12/207,801

(22) Filed: Sep. 10, 2008

(30) Foreign Application Priority Data
Sep. 14, 2007 (JP) 2007-240086

(51) Int. Cl. G06F 15/16

(52) U.S. Cl. 709/203

(57) ABSTRACT

A network device providing a service to a client device connected via a network. An information providing section provides information that promotes accessing the service by the client device. A service execution section executes the requested service according to a request from the client device based upon information provided by the information providing section. The information providing section and the service execution section are booted as separate processes.

### BACKGROUND OF THE INVENTION

1. Field of the Invention

The present invention generally relates to a network device, a service providing method, and a service providing program, and more specifically, to a network device, service providing method, and service providing program provided via a network.

2. Description of the Related Art

In recent years, standard specifications (WS-Discovery, WS-Transfer, WS-MetadataExchange, WS-Eventing, etc.) for using Web services provided by devices on the network have been established. According to the corresponding specifications, the client side can use the Web services provided by each device without being conscious of the device vendor or model. Therefore there is merit in being able to cut development labor-hours for the client side and an expansion of choice of which device to use for the user side.

What is set down in the above specifications mainly pertains to interface, and the decision of how to install each function is left up to each vendor.

For example, for a built-in type device such as an image forming apparatus the constraint on memory is severe. Thus when installing the function it is preferable to have a structure which uses as little memory as possible. Also, there is a need to consider from the point of development and maintenance operational efficiency a preferable configuration.

(Patent article 1) Japanese Laid-Open Patent Application 2007-102802

(Patent article 2) Japanese Laid-Open Patent Application 2007-148828

(Non-patent article 1) “Web Service Dynamic Discovery (WS-Discovery)”, online, retrieved Sep. 7, 2007, <http://schemas.xmlsoap.org/ws/2005/04/discovery/>

(Non-patent article 2) “Web Service Transfer (WS-Transfer)”, online, retrieved Sep. 7, 2007, <http://www.w3.org/Submission/WS-Transfer/>

(Non-patent article 3) “Web Service Metadata Exchange (WS-MetadataExchange)”, online, retrieved Sep. 7, 2007, <http://specs.xmlsoap.org/ws/2004/09/mex/WS-MetadataExchange.pdf>

(Non-patent article 4) “Web Service Eventing (WS-Eventing)”, online, retrieved Sep. 7, 2007, <http://www.w3.org/Submission/WS-Eventing/>

### SUMMARY OF THE INVENTION

Accordingly, embodiments of the present invention may provide a novel and useful network device, a service providing method, and a service providing program solving one or more of the problems discussed above.

More specifically, the embodiments of the present invention may provide a network device, service providing method, and service providing program with an appropriate structure that may provide services in view of the above points.

One aspect of the present invention may be to provide a network device with the potential to provide services to a client device connected via a network, comprising an information providing section to provide information that promotes the accessing of a service to the client device, and a service execution section to execute the requested service according to the request from the client device based upon the information provided from the information providing section, wherein the information providing section and the service execution section are booted as separate processes.

In the network device according to an embodiment of the present invention, services may be provided with an appropriate structure.

In the network device, service providing method, and service providing program according to an embodiment of the present invention, services may be provided with an appropriate structure.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram illustrating a network system structure according to an embodiment of the present invention;

FIG. 2 is a schematic diagram illustrating a multifunction machine structure according to an embodiment of the present invention;

FIG. 3 is a diagram illustrating the functional structure pertaining to the Web service providing function of the network control section;

FIG. 4 is a sequence diagram illustrating the process of the service information providing section upon booting;

FIG. 5 is a sequence diagram illustrating the process of the service section upon booting;

FIG. 6 is a Hello message example announcing the presence of a service;

FIG. 7 is a sequence diagram illustrating the process of the service section upon termination;

FIG. 8 is a sequence diagram illustrating the process of the service information providing section upon termination;

FIG. 9 is a Bye message example announcing the termination of a service;

FIG. 10 is a flowchart illustrating an overview of the process of the preprocessing to receive a service;

FIG. 11 is a sequence diagram illustrating the search processing of services;

FIG. 12 is a Probe message example;

FIG. 13 is a ProbeMatch message example;

FIG. 14 is a ProbeMatch message example when there are multiple services that match a search;

FIG. 15 is a Get message example;

FIG. 16 is a GetResponse message example;

FIG. 17 is a GetResponse message example;

FIG. 18 is a GetResponse message example when there are multiple services present;

FIG. 19 is a GetResponse message example when there are multiple services present;

FIG. 20 is a GetResponse message example when there are multiple services present;

FIG. 21 is a sequence diagram illustrating the acquisition process of the basic information of a service;

FIG. 22 is a message example illustrating the acquisition request for the basic information of a service;

FIG. 23 is a reply message example to the acquisition request for the basic information of a service;

FIG. 24 is a sequence diagram illustrating the registration process of an event, which requests notification;

FIG. 25 is a Subscribe message example;

FIG. 26 is a Subscribe message example;

FIG. 27 is a reply message example to the request for event registration;

FIG. 28 is a flowchart illustrating an overview of the process upon service use;

FIG. 29 is a sequence diagram illustrating the process upon service execution;

FIG. 30 is the first example of a message requesting service execution;

FIG. 31 is the first example of a reply message to the service execution request;

FIG. 32 is the second example of a message requesting service execution;

FIG. 33 is the second example of a message requesting service execution;

FIG. 34 is the second example of a reply message to the service execution request;

FIG. 35 is a sequence diagram illustrating the process upon event occurrence;

FIG. 36 is a message example reporting the event; and

FIG. 37 is a schematic diagram illustrating the hardware structure of a multifunction machine according to an embodiment of the present invention.

### DETAILED DESCRIPTION OF THE PREFERRED EMBODIMENTS

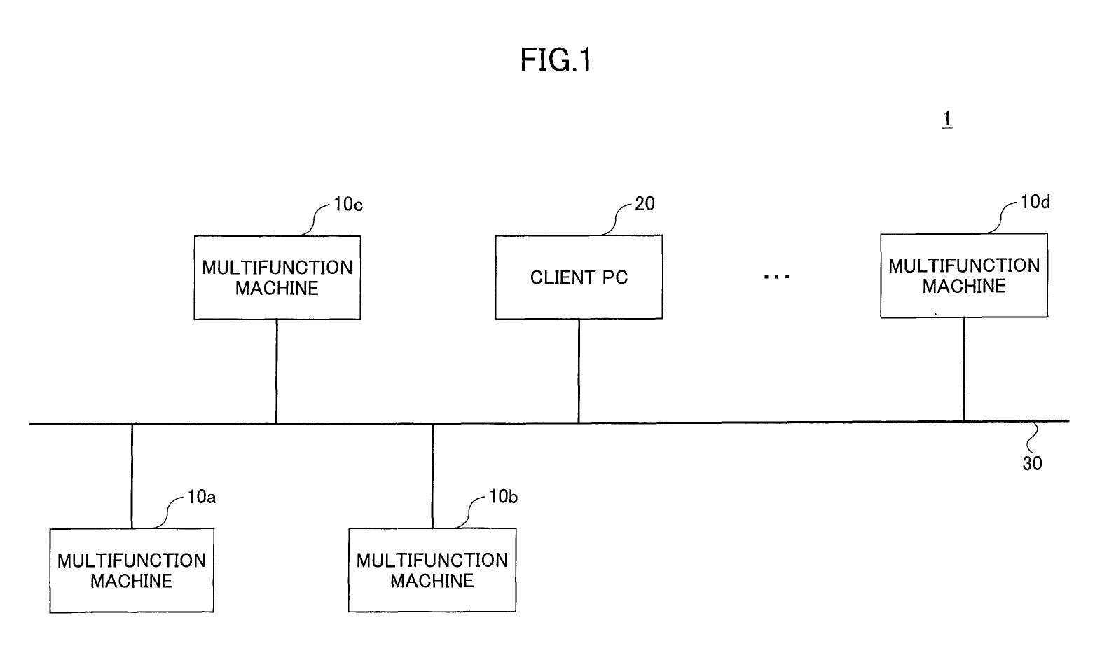

A description is given below, with reference to the FIG. 1 through FIG. 37 of embodiments of the present invention.

Shown in FIG. 1, is a schematic diagram illustrating a network system structure according to an embodiment of the present invention. In FIG. 1, the network system is comprised of more than a single multifunction machine 10a, 10b, 10c, and 10d (hereinafter referred to as “multifunction machine 10” collectively), and more than a single client PC such as client PC 20. The multifunction machine 10 and the client PC 20 are connected via a network 30 (fixed line or wireless not distinguished) such as a LAN (Local Area Network).

The multifunction machine 10 is an image forming apparatus with multiple functions such as copying, faxing, scanning, and printing built into one housing. Installed in the multifunction machine 10 are various software applications which with the corresponding software that realizes a Web service according to the standard specifications for interface, provides Web services on the network 30.

The client PC 20 is a computer such as a common PC (Personal Computer) with software that enables the use of the Web service of the multifunction machine 10.

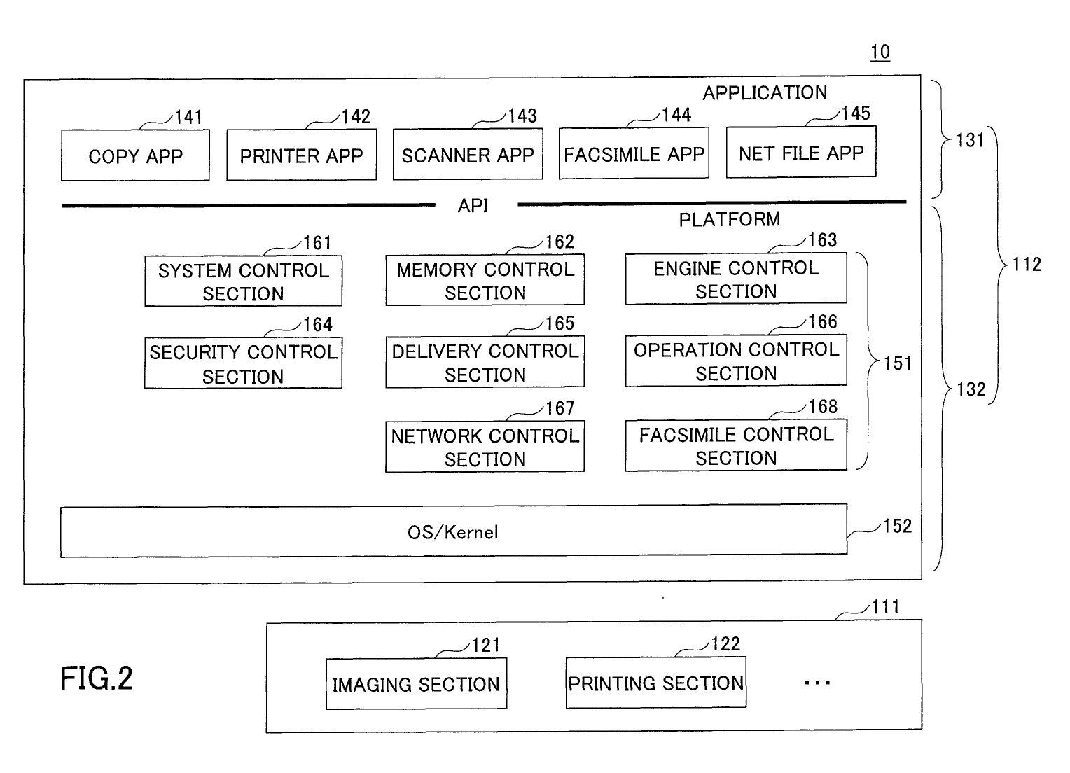

Shown in FIG. 2 is a schematic diagram illustrating a multifunction machine structure according to an embodiment of the present invention. In FIG. 2, the multifunction machine 10 is comprised of a variety of hardware devices 111 and a variety of software programs 112.

The hardware 111 of the multifunction machine 10 is comprised of an imaging section 121 and a printing section 122. The imaging section 121 is hardware that reads an image (image data) from a read document. The printing section 122 is hardware that prints the image (image data) on to a printing paper.

The software 112 of the multifunction machine 10 is broadly divided into a variety of applications 131 and a platform 132. These programs are executed in a process unit in parallel by an OS 152 (operating system) such as a UNIX (registered trademark).

The applications 131 are comprised of a copy app 141 that is the application for the copier, a printer app 142 that is the application for the printer, a scanner app 143 that is the application for the scanner, a facsimile app 144 that is the application for the facsimile, and a net file app 145 that is the application for the network file.

The platform 132 is comprised of a variety of control services 151 and the OS 152. The control services 151 are comprised of a system control section 161, a memory control section 162, an engine control section 163, a security control section 164, a delivery control section 165, an operations control section 166, a network control section 167, and a fax control section 168.

The system control section 161 controls items related to system management. The memory control section 162 controls items related to the memory and a hard disk drive. The engine control section 163 controls items related to the imaging section 121 and the printing section 122. The security control section 164 controls items related to an authentication process and an accounting process. The delivery control section 165 controls items related to the delivery process of stored documents. The operations control section 166 controls items related to an operations panel. The network control section 167 is an intermediary for network communications. The fax control section 168 provides the API of the facsimile.

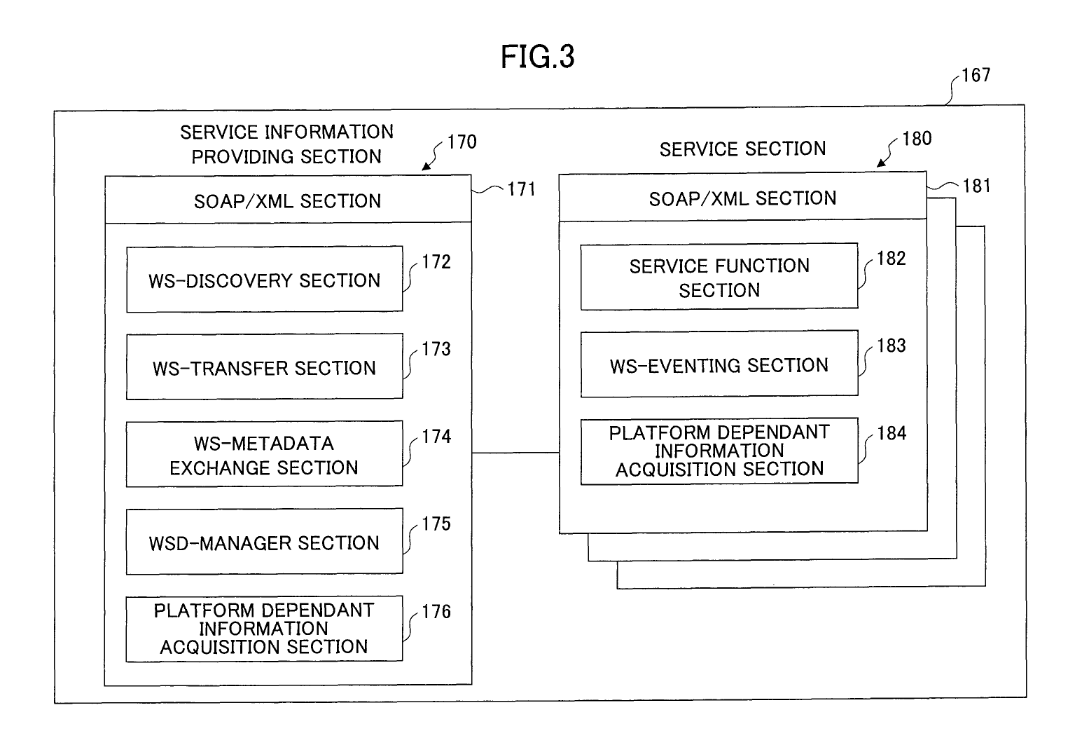

In the above structure, the software to provide the Web services according to the standard specifications is installed in the network control section 167. Shown in FIG. 3 is a diagram illustrating the functional structure pertaining to the Web service providing function of the network control section 167. As shown in FIG. 3, the Web service providing function of the network control section 167 is broadly divided into a service information providing section 170 and a service section 180. This division is a distinctive feature of this embodiment of the present invention.

The service information providing section 170 is comprised of a SOAP/XML section 171, a WS-Discovery section 172, a WS-Transfer section 173, a WS-MetadataExchange section 174, a WSD-Manager section 175, and a platform dependant information acquisition section 176, and provides information to the network 30 to promote the access to a service provided by the multifunction machine 10.

The SOAP/XML section 171 executes the serialization (conversion of data format of the program language to XML (extensible Markup Language) format) and deserialization (conversion of the XML format to the format of the program language) of communication data of the service information providing section 170.

The WS-Discovery section 172, according to the Web Services Dynamic Discovery (WS-Discovery) specifications, executes send-receive processing of messages to detect the presence of a device (multifunction machine 10) and reports the existence of or the nonexistence of a device to the client PC 20. For example, the WS-Discovery section 172 responds to a search request for a service from the client PC 20, determines the existence of or the nonexistence of the targeted service and according to the determination results returns identification information (URL) to access the corresponding service to the client PC 20. The WS-Discovery is a specification which defines the protocol to search for the desired Web service mainly with multicast; for further details refer to [http://schemas.xmlsoap.org/ws/2005/04/discovery/].

The WS-Transfer section 173, according to the Web Service Transfer (WS-Transfer) specifications, executes send-receive processing of messages to report information related to the detected devices. The WS-Transfer is a specification which defines the protocol to access the XML expressions of the Web service base resources; for further details refer to [http://www.w3.org/Submission/WS-Transfer/].

The WS-MetadataExchange section 174, according to the Web Service Metadata Exchange (WS-MetadataExchange) specifications, creates as an XML data base the service information provided from the detected devices. WS-MetadataExchange is a specification which defines the bootstrap scheme for message exchange based upon metadata for the Web service; for further details refer to [http://specs.xmlsoap.org/ws/2004/09/mex/WS-MetadataExchange.pdf]

The WSD-Manager section 175 controls and manages the service information providing section 170 and the service section 180. Also, the WSD-Manager section 175 comprehends what services can be provided at present by the service section 180.

The platform dependant information acquisition section 176, from the information used by the service information providing section 170, effects/executes for information with acquisition methods depending upon the platform (for example, information related to applications or hardware, hereinafter referred to as “platform dependent information”) an absorption of the dependent part and provides a non-platform dependent interface to each section of the service information providing section 170. Therefore when running the service information providing section 170 on a different platform the difference of the platforms is absorbed by the platform dependant information acquisition section 176 and the need to change the other sections is reduced.

Note that within the service information providing section 170, the WS-Discovery section 172, the WS-Transfer section 173, the WS-MetadataExchange section 174, and the WSD-Manager section 175 are booted as different threads.

The service section 180 is comprised of a SOAP/XML section 181, a service function section 182, a WS-Eventing section 183, and a platform dependent information acquisition section 184, and executes the process to provide the corresponding service.

The SOAP/XML section 181 executes the serialization (conversion of data format of the program language to XML format) and deserialization (conversion of the XML format to the format of the program language) of communication data of the service section 180.

The service function section 182 executes the requested service according to the request from the client PC 20.

The WS-Eventing section 183, according to the Web Service Eventing (WS-Eventing) specifications, executes announcement of the occurrence of an asynchronous event to that of the request from the client PC 20 in the service provided by the service function section 182. The WS-Eventing is a specification which defines the protocol related to the announcement of events by the Web service; for further details refer to [http://www.w3.org/Submission/WS-Eventing/].

The platform dependent information acquisition section 184, from the information used by the service section 180, effects/executes for platform dependent information an absorption of the dependent part and provides a non-platform dependant interface to each section of the information providing section 180.

Note that within the service section 180, the service function section 182 and the WS-Eventing section 183 are booted as different threads.

According to an embodiment of the present invention, only a single service information providing section 170 is installed regardless of the number of services (types). In contrast, a service section 180 is installed for each service (for each function). Also the service information providing section 170 and the service section 180 are booted as separate processes and the service section 180 boots each service as a separate process.

By establishing the service information providing section 170 and the service section 180 as separate processes the dependency relationship between the information providing function of the service and the actual execution function of the service can be reduced. Therefore when adding a new service (function), a new service section 180 can be installed without being dependent upon the makeup of the service information providing section 170. Also, the influence (revision to the source code, etc.) of adding a new service section 180 to the service information providing section 170 can be reduced.

Also, when in operation if a failure occurs to either of the sections the influence on the operations of the other section can be reduced. More specifically, when the service information providing section 170 and the service section 180 are encompassed as one process and when a failure occurs to either of the sections and the process is terminated, the function of the other section will also be terminated. By separating the process of the service information providing section 170 and the service section 180 and when a failure occurs in either of the sections and one process is terminated, the other process will not be influenced and will keep executing its function.

Also, by segregating the process of each service of the service section 180s the dependency relationship between services can be reduced. Therefore when adding a new service, influence on the pre-existing service sections 180 can be reduced, and influence of the pre-existing service sections 180 on the new service section 180 can be reduced as well. Also, when in operation and if a failure occurs to one of the service sections 180, the influence on the operations of the other service sections 180 can be reduced.

By arranging the processes of the WS-Discovery section 172, the WS-Transfer section 173, the WS-MetadataExchange section 174, and the WSD-Manager section 175 as separate processes and also the service function section 182 and the WS-Eventing section 183 as separate processes the dependency relationship can be further reduced at a finely divided level. An increase in processes results in an increase of memory demand. Especially in a built-in type of device such as an image forming apparatus where the memory constraint is severe, an increase in memory demand leads to an increase in cost of the device itself and is not desirable. Thus, the inventor of the present invention considered the need to balance a reduction in the dependency relationship (in other words, the separation of processes) and the increase of memory demand due to the separation of processes and came up with the structure shown in FIG. 3.

In the following the reason is explained for including the four sections, the WS-Discovery section 172, the WS-Transfer section 173, the WS-MetadataExchange section 174, and the WSD-Manager section 175 in the service information providing section 170 and the two sections, the service function section 182 and the WS-Eventing section 183 in the service section 180 (in other words, the reason why the processes are divided into the prior four and the latter two). The predominant reasons are first from the viewpoint of the need to install functions and second from the viewpoint of the dependency relationship between the specific contents of each service.

More specifically, to realize information providing encouraging the target audience to access the services there is a need for at least the WS-Discovery section 172, the WS-Transfer section 173, the WS-MetadataExchange section 174, and the WSD-Manager section 175 and to realize the execution process of the services there is a need for at least the service function section 182 and WS-Eventing 183 (the first reason).

Also the contents of the WS-Discovery section 172, the WS-Transfer section 173, the WS-MetadataExchange section 174, and the WSD-Manager section 175 do not change according to the service contents, although the contents of the service function section 182 and the WS-Eventing section 183 do change according to the service (the second reason). Note that the contents of events differ according to the service and thus the contents of the WS-Eventing section 183 change depending upon the service.

In the following shall be explained the process of the network system 1 centered upon the actions of the network control section 167.

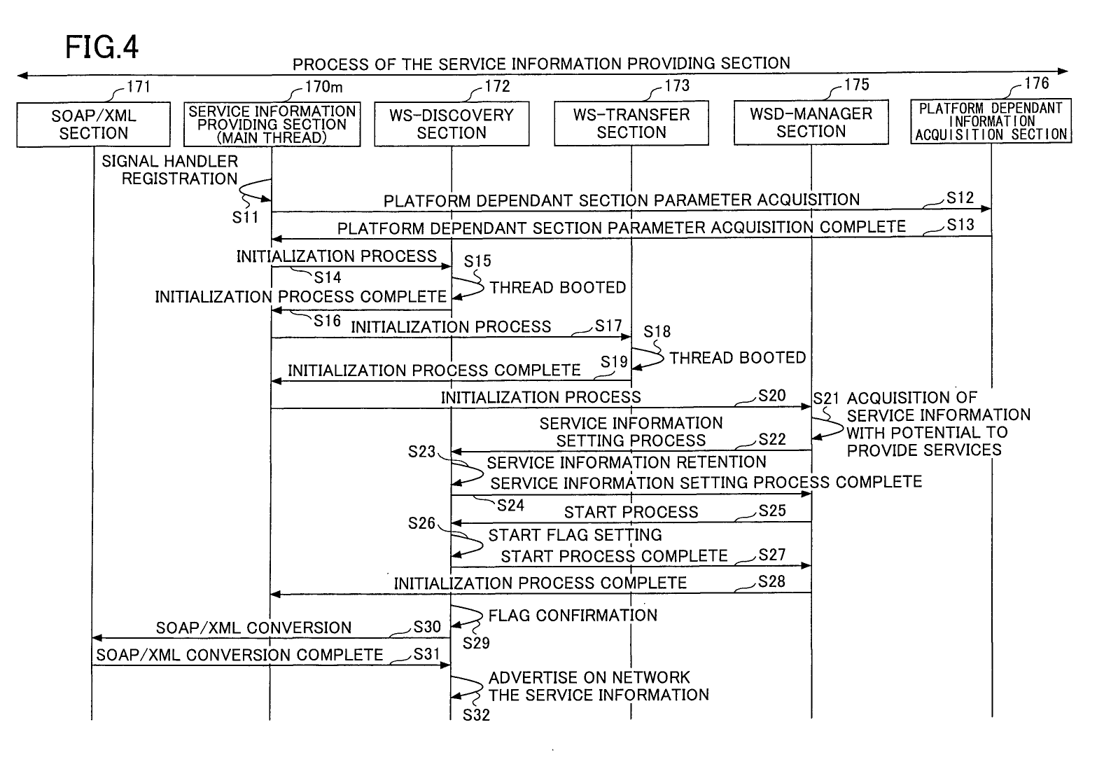

Shown in FIG. 4 is a sequence diagram illustrating the process of the service information providing section upon booting. The corresponding sequence is executed, for example, upon booting the multifunction machine 10.

When the process of the service information providing section 170 is booted (created) by the OS 152 the main thread 170m of the service information providing section 170 registers the signal handler (S11). The signal handler is, when a signal is generated, a function which executes processing according to the signal in an interrupt manner. Next, the main thread 170m acquires via the platform dependent information acquisition section 176 necessary information (service information) from the platform dependant information for the advertisement upon booting (S12, S13).

Next, by initializing the WS-Discovery section 172 the main thread 170m boots as a thread the WS-Discovery section 172 (S14˜S16). Then by initializing the WS-Transfer section 173 the main thread 170m boots as a thread the WS-Transfer section 173 (S17˜S19)

Next, by initializing the WSD-Manager section 175 the main thread 170m boots as a thread the WSD-Manager section 175 (S20, S21). The WSD-Manager section 175 acquires the service information from the main thread 170m (S21) and sets the corresponding service information in the WS-Discovery section 172 (S22). The WS-Discovery section 172 retains (records) the service information in a predetermined memory area (S23) and notifies the WSD-Manager section 175 of the completion of setting the service information (S24).

Next, the WSD-Manager section 175 requests the WS-Discovery section 172 to execute the process (start process) of advertising the service information (S25). The WS-Discovery section 172 sets the flag (Start Flag) ON to identify the necessity of advertisement of the service information (S26) and reports the completion of the start process to the WSD-Manager section 175 (S27). The WSD-Manager section 175 reports the completion of the initialization process to the main thread 170m (S28).

When the WS-Discovery section 172 confirms that the Start Flag is ON (S29) it has the SOAP/XML section 171 execute the serialization of the set service information (S30, S31). Then the WS-Discovery section 172 transmits (multicast) on the network 30 a Hello message, which includes the service information converted into SOAP format, then turns the Start Flag to OFF (S32). The Hello message is a message to announce the presence of a device or service and is specified in the WS-Discovery specifications.

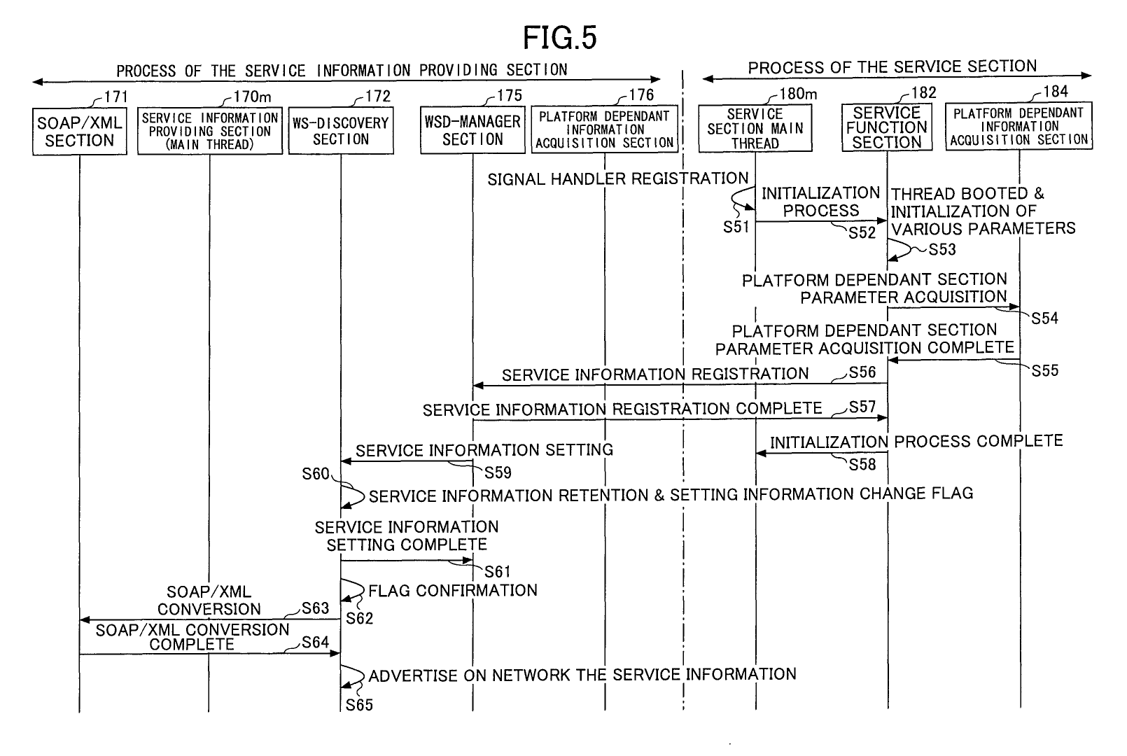

The following is an explanation of the process upon booting the service section 180, which provides services (for example, printing service). Shown in FIG. 5 is a sequence diagram illustrating the process of the service section upon booting.

When the process of the service section 180 is booted by the OS 152, the main thread 180m of the service information providing section 170 registers the signal handler (S51). Next the main thread 180m boots as a thread the service function section 182 by initializing the service function section 182 of the corresponding service section 180 (S52, S53). Upon being booted as a thread the service function section 182 initializes the various parameters.

Next, the service function section 182 via the platform dependant information acquisition section 184 of the corresponding service section 180 acquires from the platform dependant information the service information of the corresponding service section 180 (S54, S55). Then the service function section 182 registers the service information (information pertaining to service identification name and location such as the URL) in the WSD-Manager section 175 (S56, S57) and reports the completion of the initialization process to the main thread 180m (S58), hereby completing the process of the service section 180.

The WSD-Manager section 175, with registered service information, sets the corresponding service information in the WS-Discovery section 172 (S59). The WS-Discovery section 172 retains (records) the service information in a predetermined memory area and to identify the change to the set information turns ON the setting information conversion flag (S60), then reports the completion of the setting of the service information to the WSD-Manager section 175 (S61).

When the WS-Discovery section 172 confirms that the setting information conversion flag is ON (S62) it has the SOAP/XML section 171 execute the serialization of the set service information (S63, S64). Then the WS-Discovery section 172 transmits (multicast) on the network 30 a Hello message, which includes the service information converted into SOAP format and turns OFF the setting information conversion flag (S65).

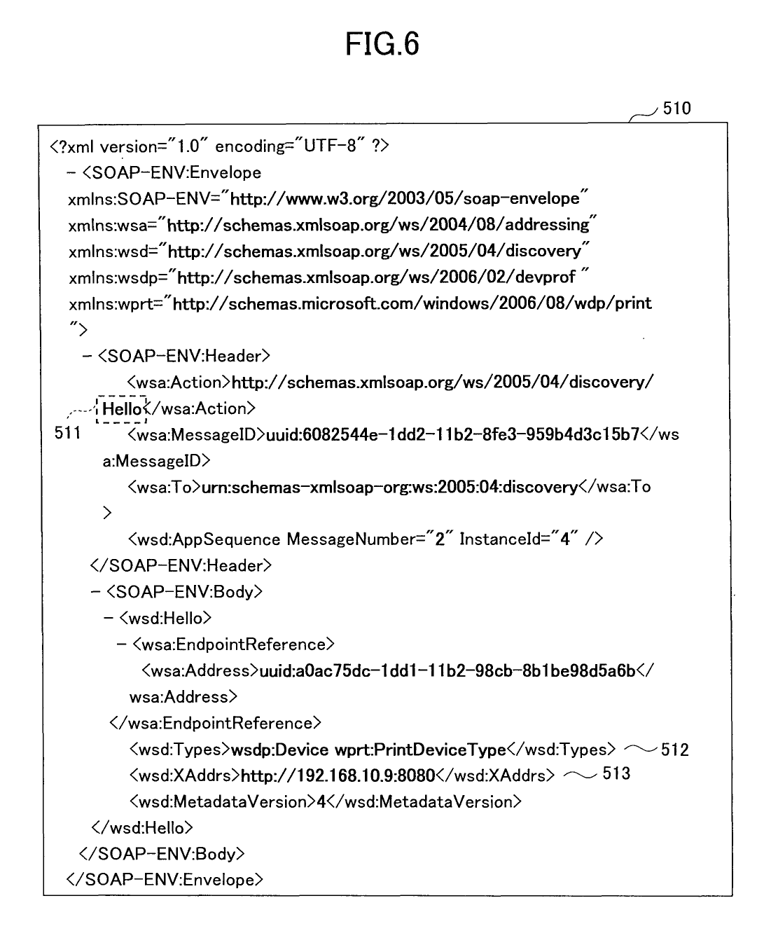

Shown in FIG. 6 is a Hello message example announcing the presence of a service. In the message 510 of FIG. 6 the “Hello” description 511 identifies message 510 as a Hello message.

In description 512, “wsdp:Device” indicates the presence of the device and the “wprt:PrintDeviceType” gives the identification name of the service, which can be provided by the booted service section 180. The URL in description 513 shows the location of the service section 180.

Note the process of FIG. 5 is executed every time a service section 180 is booted.

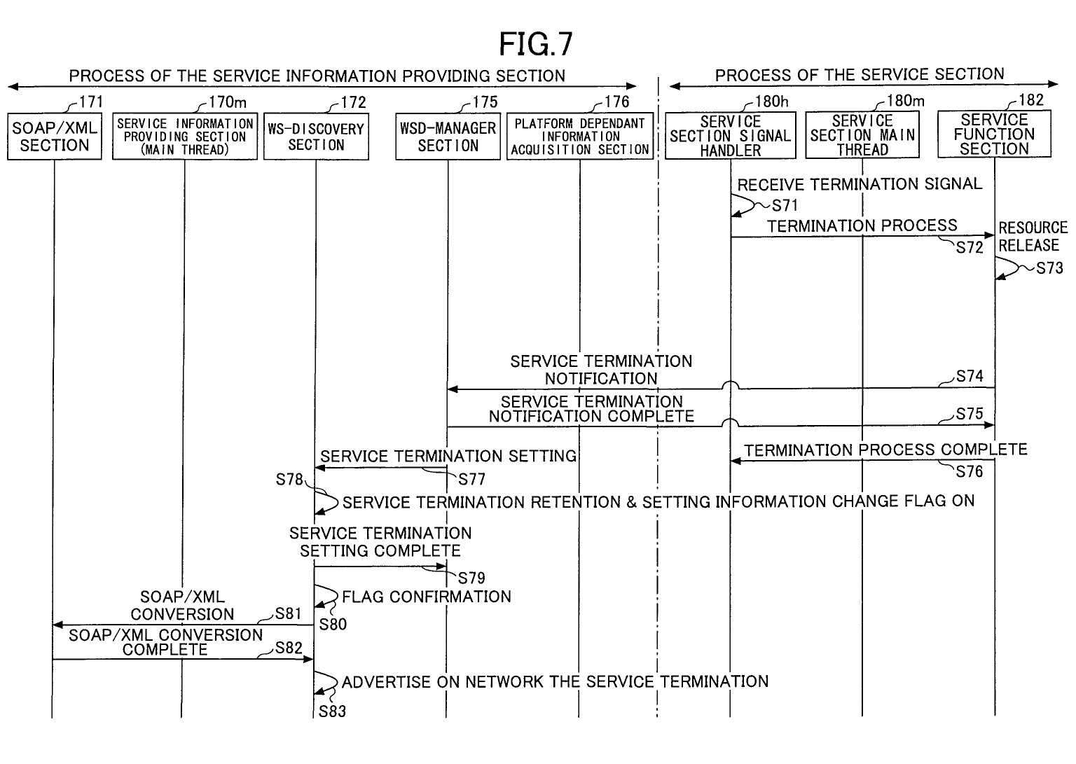

The following is an explanation of the process upon termination of a service section 180. Shown in FIG. 7 is a sequence diagram illustrating the process of the service section upon termination.

When the signal handler 180h detects a termination signal according to some occurrence (for example, input from the user) (S71), the signal handler 180h sends a request for an execution of a termination process to the service function section 182 (S72). The service function section 182 executes the release of resources (S73) and the corresponding service section 180 reports the termination of the service to the WSD-Manager section 175 (S74, S75). Then the service function section 182 notifies the signal handler 180h of the completion of the termination process (S76). Afterward the process of the corresponding service section 180 terminates.

The WSD-Manager section 175 notified of the termination of the service sets the termination of the corresponding service in the WS-Discovery section 172 (S77). The WS-Discovery section 172 retains (records) the information representing the termination of the service in a predetermined memory area and turns ON the setting information conversion flag (S78) then reports the completion of setting the termination of the service to the WSD-Manager section 175 (S79).

When the WS-Discovery section 172 confirms that the setting information conversion flag is ON (S80), it has the SOAP/XML section 171 execute the serialization of the information representing the set termination of the service (S81, S82). Then the WS-Discovery section 172 transmits (multicast) on the network 30 a Bye message which includes the information representing service termination converted into SOAP format and turns OFF the setting information conversion flag (S83). The Bye message is specified by the WS-Discovery specifications.

Note the process of FIG. 7 is executed every time a termination of a service section 180 is executed.

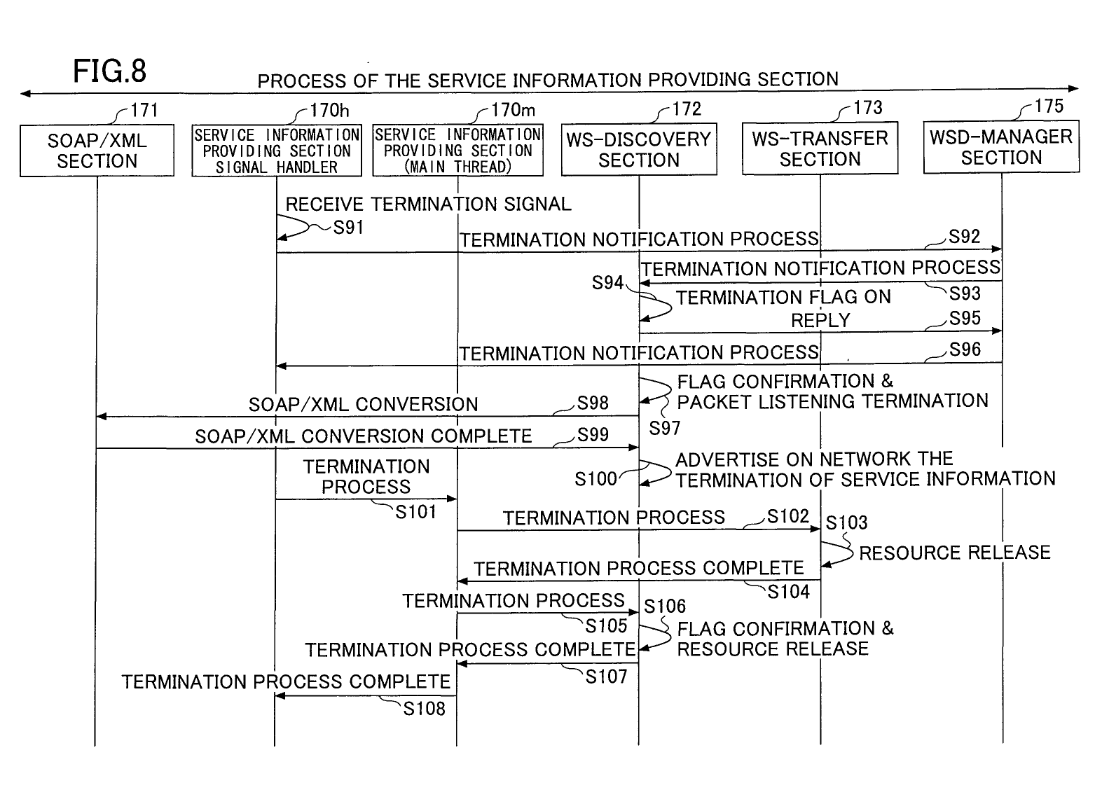

The following is an explanation of the process upon termination of the service information providing section 170. Shown in FIG. 8 is a sequence diagram illustrating the process of the service information providing section upon termination.

When the signal handler 170h detects a termination signal according to some occurrence (for example, input from the user) (S91), the signal handler 170h sends a request for an execution of a termination notification process to the WSD-Manager section 175 (S92). The WSD-Manager section 175 sends a request for an execution of a termination notification process to the WS-Discovery section 172 (S93). The WS-Discovery section 172 turns the termination flag ON (S94) and notifies the WSD-Manager section 175 of the recognition of the termination notification (S94). Then the WSD-Manager section 175 notifies the signal handler 170h of the execution of a termination notification process (S96).

When the WS-Discovery section 172 confirms that the termination flag is ON, it terminates listening for the packet (closes the socket for listening) (S97). Next the WS-Discovery section 172 has the SOAP/XML section 171 executes the serialization of the information representing the termination of the service information providing section 170 (S98, S99). Then the WS-Discovery section 172 transmit (multicast) on the network 30 the Bye message converted into SOAP format and turns OFF the termination flag (S100).

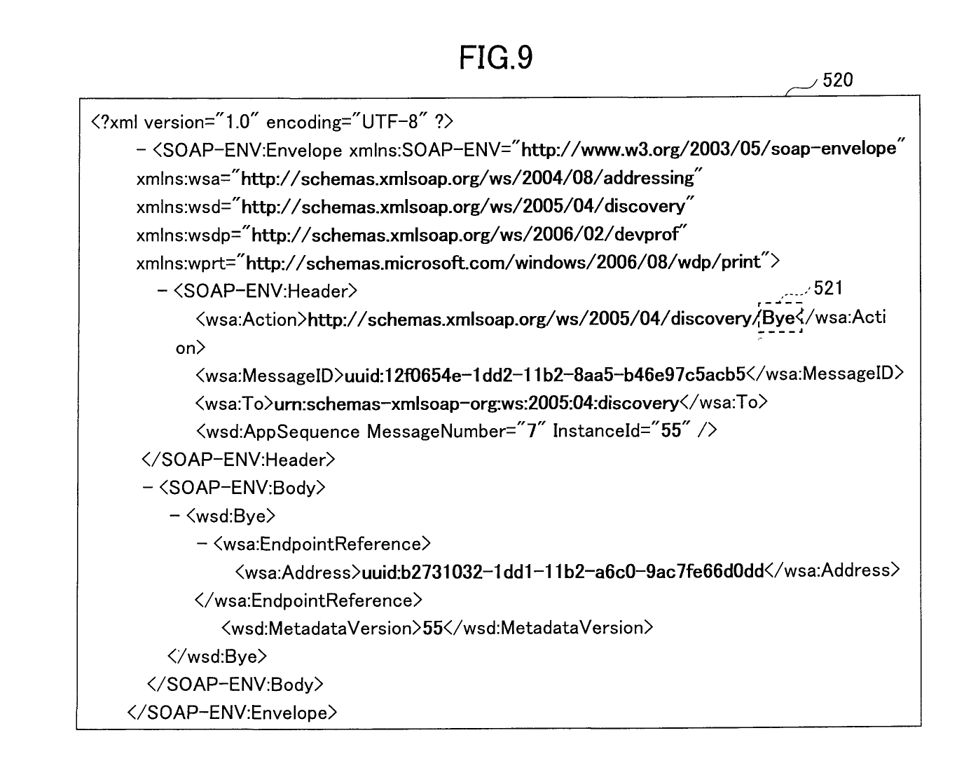

Shown in FIG. 9 is a Bye message example announcing the termination of a service. The “Bye” description 521 identifies the message 520 as a message of service termination.

Next, the signal handler 170h sends a request for the execution of the termination process to the main thread 170m (S101). The main thread 170m sends the request for the termination process to the WS-Transfer section 173 (S102). The WS-Transfer section 173 executes the release of the resources (S103) and reports the completion of the termination process to the main thread 170m (S104). Next the main thread 170m sends a request for the termination process to the WS-Discovery section 172 (S105). The WS-Discovery section 172 confirms that the various flags are OFF and executes the release of resources (S106) and reports the completion of the termination process to the main thread 170m (S107). Then the main thread 170m reports the completion of the termination process to the signal handler 170h (S108). Afterward the process of the service information providing section 170 terminates.

The process of booting and termination of the service information providing section 170 and the service section 180 are as described above though the booting of the service information providing section 170 and the booting of the service section 180 do not have to be executed (synchronized) consecutively. Also in the same way, the termination of the service information providing section 170 and the termination of the service section 180 do not have to be executed (synchronized) consecutively. For example, when the service section 180 is booted or terminated as necessary, the booting or termination of the service information providing section 170 and the booting or termination of the service section 180 are asynchronous. According to an embodiment of the present invention the service information providing section 170 and the service section 180 are structured as separate processes enabling this flexible booting or termination sequence. Therefore by booting only the necessary service section 180, memory demand can be curbed.

The following is an explanation of the pre-processing necessary for the client PC 20 to receive a service, when the service information providing section 170 and the service section 180 of the multifunction machine 10 are booted and the service section 180 is advertising the information.

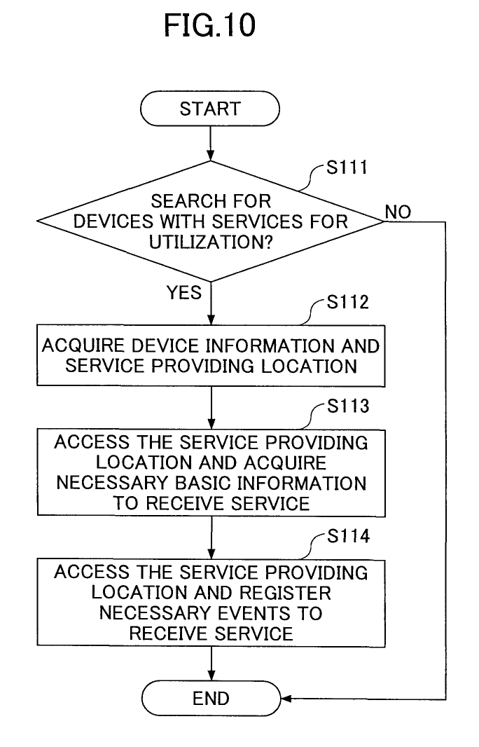

Shown in FIG. 10 is a flowchart illustrating an overview of the process of the preprocessing to receive a service.

In step S111, the client PC 20 searches for the multifunction machine 10 with the service that the client PC 20 wants to utilize. When the multifunction machine 10 with the corresponding service is located (Yes in S111) the client PC 20 acquires the information of the located multifunction machine 10 and the information (URL) showing the location where the service is provided (S112). Next, the client PC 20 accesses the location where the service is provided and acquires the basic information necessary to receive the provided service (S113). Then the client PC 20 accesses the location where the service is provided and registers the events necessary to receive the service (S114).

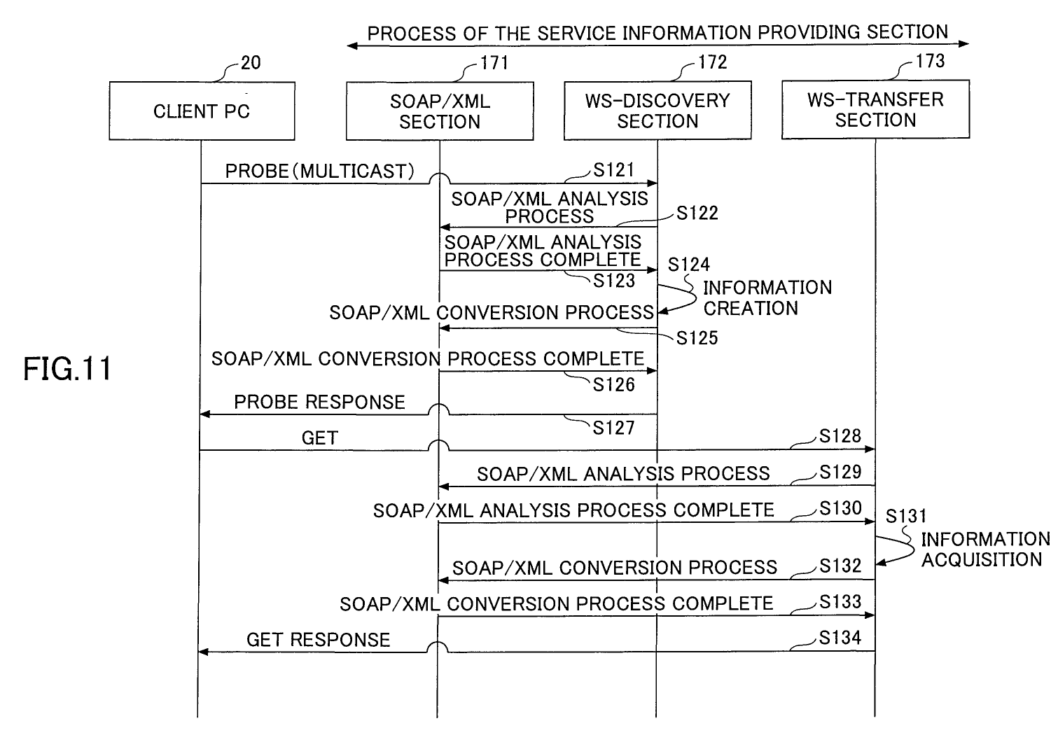

The following is a detailed explanation of the steps. FIG. 11 is a sequence diagram illustrating the search process for services. The process of FIG. 11 corresponds to the steps S111 and S112 of FIG. 10.

In step S121, the client PC 20, according to the WS-Discovery specifications multicasts upon network 30 a Probe message specified as a message to search for services.

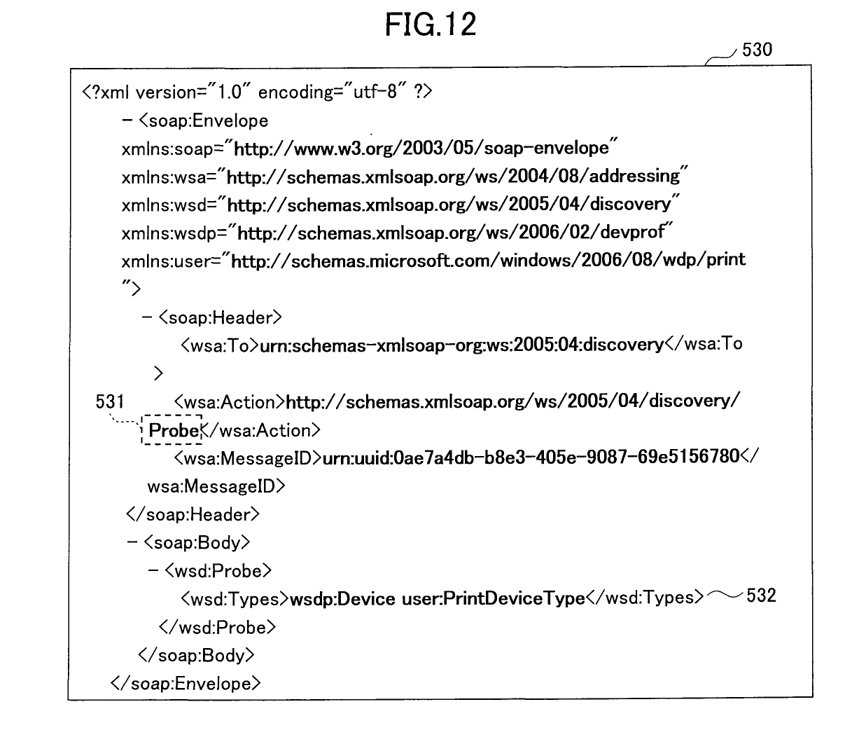

Shown in FIG. 12 is a Probe message example. In the message 540 of FIG. 12 the “Probe” description 531 identifies message 530 as a Probe message. The searched for target service is identified by the identification name (wprt:PrintDeviceType) in the description 532.

In the multifunction machine 10, when the WS-Discovery section 172 of the service information providing section 170 receives a Probe message, it has the SOAP/XML section 171 execute the deserialization of the corresponding Probe message (S122, S123). Then the WS-Discovery section 172 determines whether the searched for target service exists in an utilizable state for the device/client PC 20 (if the service section 180 corresponding to the corresponding service is booted/active) based upon the set service information and according to the determination results creates reply information (S124). Then the WS-Discovery section 172 has the SOAP/XML section 171 execute the serialization of the reply information (S125, S126) and returns to the client PC 20 a message including the serialized reply information as a reply to the Probe message (S127). For example, when the searched for target service exists, according to the WS-Discovery specifications, a ProbeMatch message is returned.

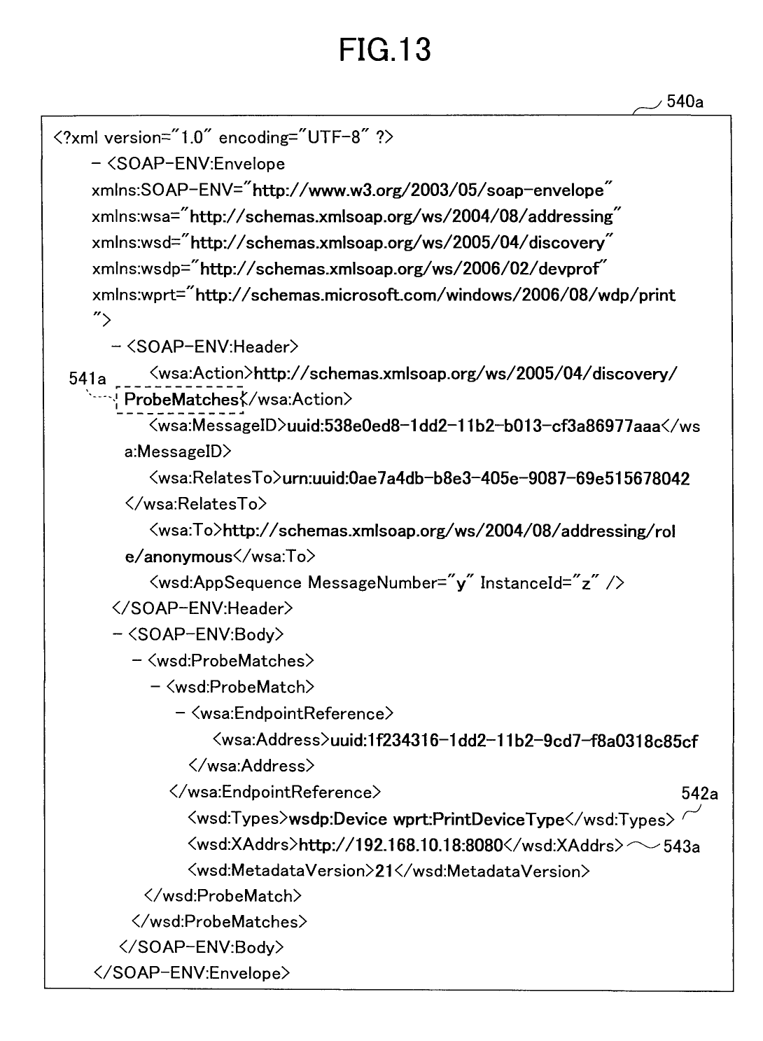

Shown in FIG. 13 is a ProbeMatch message example. In the message 540a of FIG. 13, the “ProbeMatches” description 541a identifies the message 540a as a ProbeMatch message. The identification name (wprt:PrintDeviceType) of the service matched by the search is described in the description 542a. Also, in the description 543a is given the URL that shows the providing location of the corresponding service.

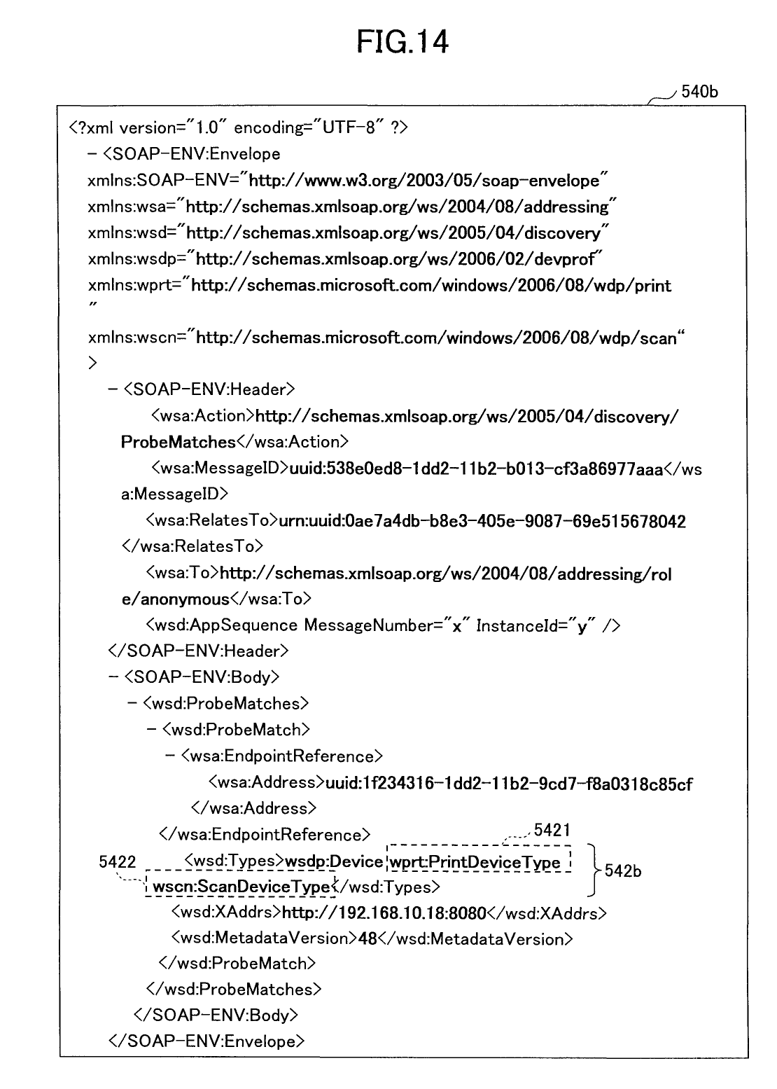

Shown in FIG. 14 is a ProbeMatch message example when there are multiple services that match a search.

In the message 540b of FIG. 14, the description 542b shows two service identification names, the identification name 5421 and the identification name 5422. The other parts are the same as FIG. 13.

The client PC 20 that has received the ProbeMatch message sends to the multifunction machine 10 that has returned the corresponding message, according to the WS-Transfer specifications, the Get message showing the request for the acquisition of information of the multifunction machine 10 (S128).

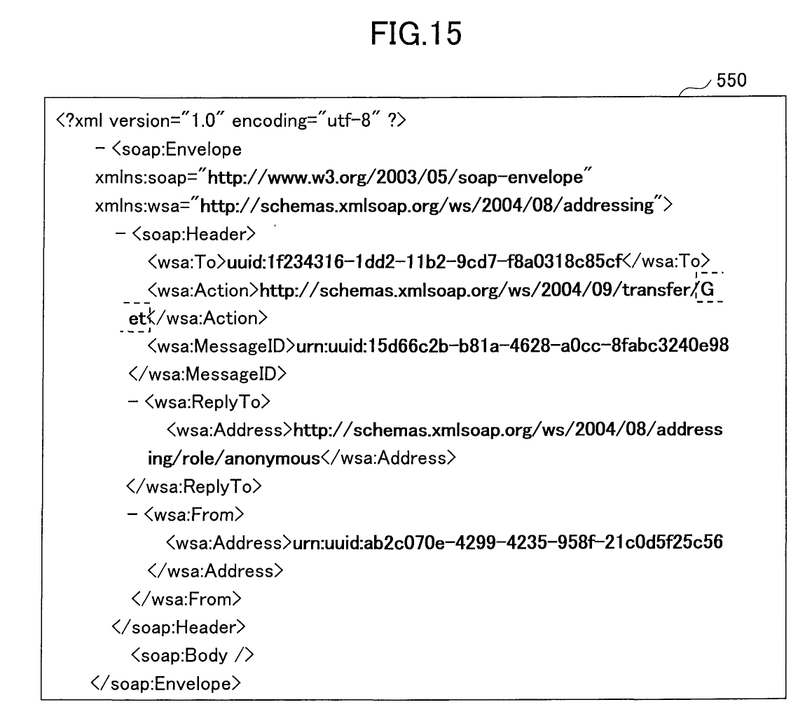

Shown in FIG. 15 is a Get message example. In the message 550 of FIG. 15, the “Get” description 551 identifies message 550 as a Get message.

In the multifunction machine 10, the WS-Transfer section 173 that has received the Get message has the SOAP/XML section 171 execute the deserialization of the Get message (S129, S130) and acquires the information of multifunction machine 10 (S131). Then the WS-Transfer section 173 has the SOAP/XML section 171 execute the serialization of the acquired information (S132, S133) and according to the WS-Transfer specifications returns to the client PC 20 the GetResponse message that includes the information of the multifunction machine 10 (S134).

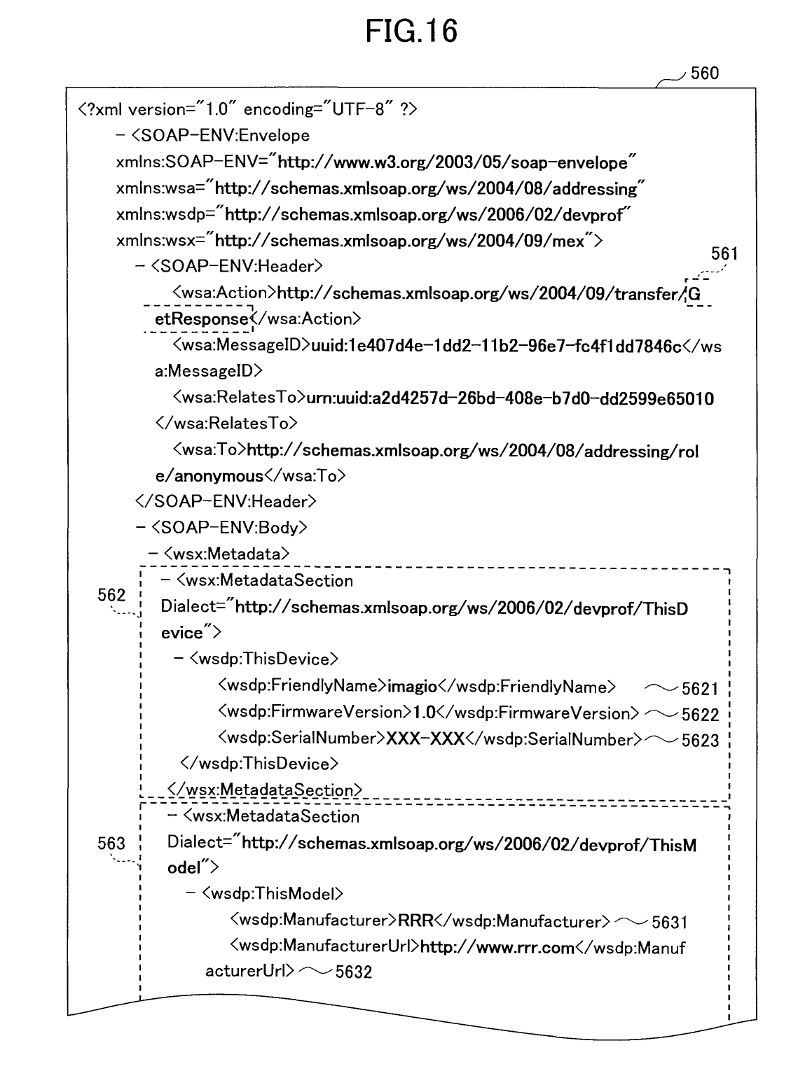

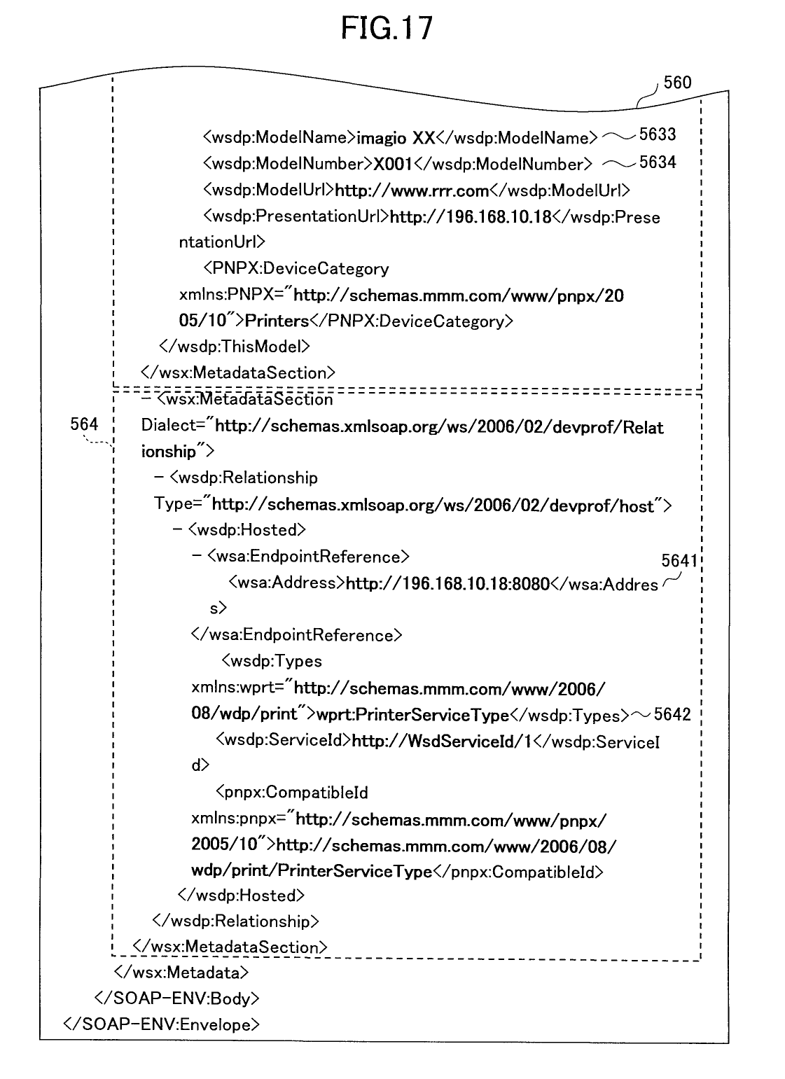

Shown in FIG. 16 and FIG. 17 are GetResponse message examples. In the message 560 of FIG. 16, the “GetResponse” description 561 identifies message 550 as a GetResponse message.

In the message 560 the information of the multifunction machine 10 is described in each MetadataSection element framed by <MetadataSection> tags. For example, in the MetadataSection 562 information related to the device (multifunction machine 10) is described. For example, in the description 5621 is the name of the device, in the description 5622 is the version of the firmware, and in the description 5623 is the serial number of the device.

Also, in the MetadataSection element 563 is information related to the model (device type). For example, in the description 5631 is the name of the manufacturer, in the description 5632 is the URL of the manufacturer, in the description 5633 is the name of the model, and in the description 5634 is the model number.

Also, in the MetadataSection element 564 information related to the service is described. For example, in the description 5641 is the URL showing the location of the service and in the description 5642 is the identification name of the service.

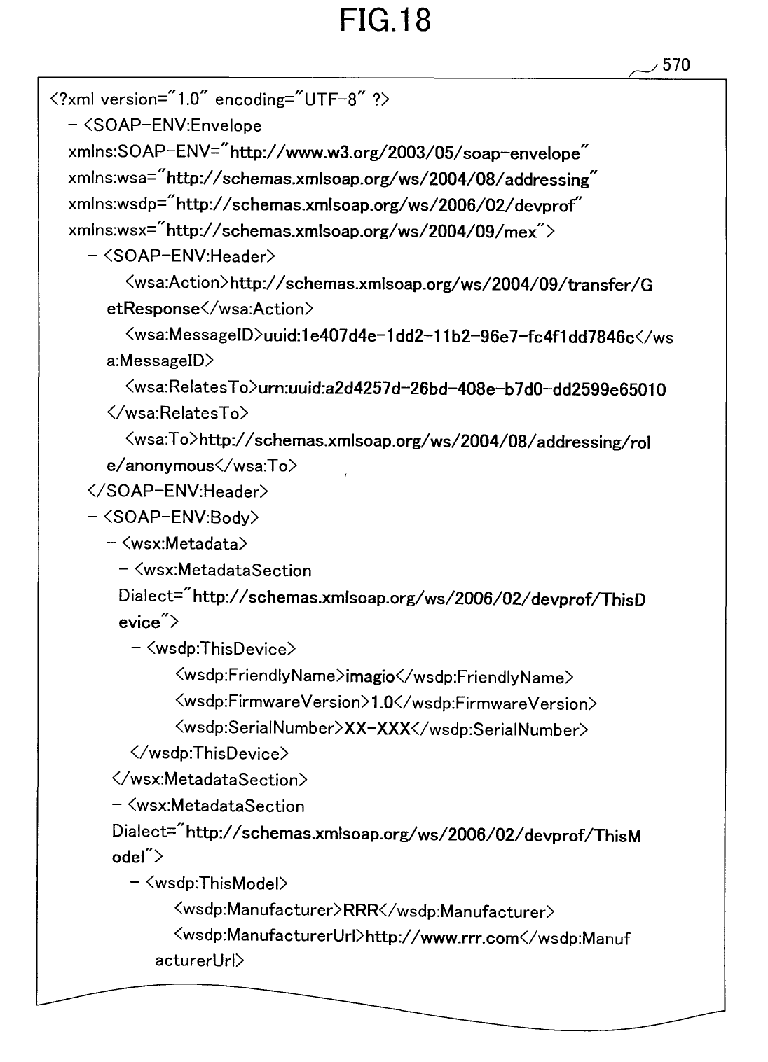

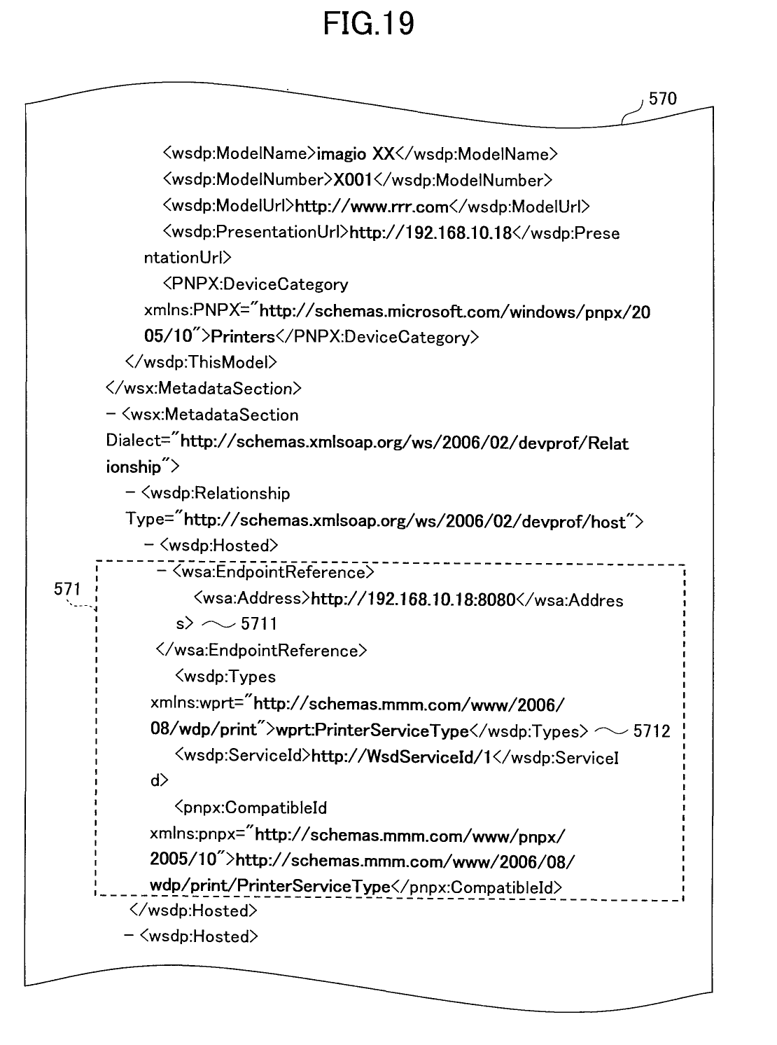

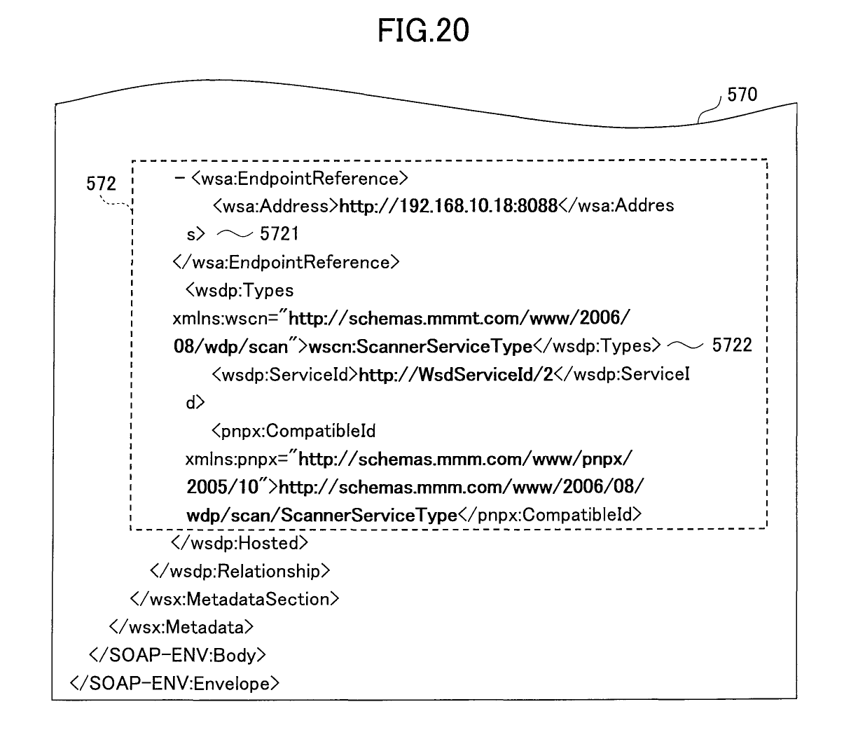

Shown in FIG. 18, FIG. 19, and FIG. 20 are GetResponse message examples when there are multiple services present. In the message 570 of FIG. 18, FIG. 19, and FIG. 20 there are two MetadataSection elements that describe information related to the service. In the MetadataSection element 571 the description 5711 gives the location of the service and the description 5712 gives the identification name of the service. Also, in the MetadataSection element 572 the description 5721 gives the location of the service and the description 5722 gives the identification name of the service. The other items are the same as the message 560.

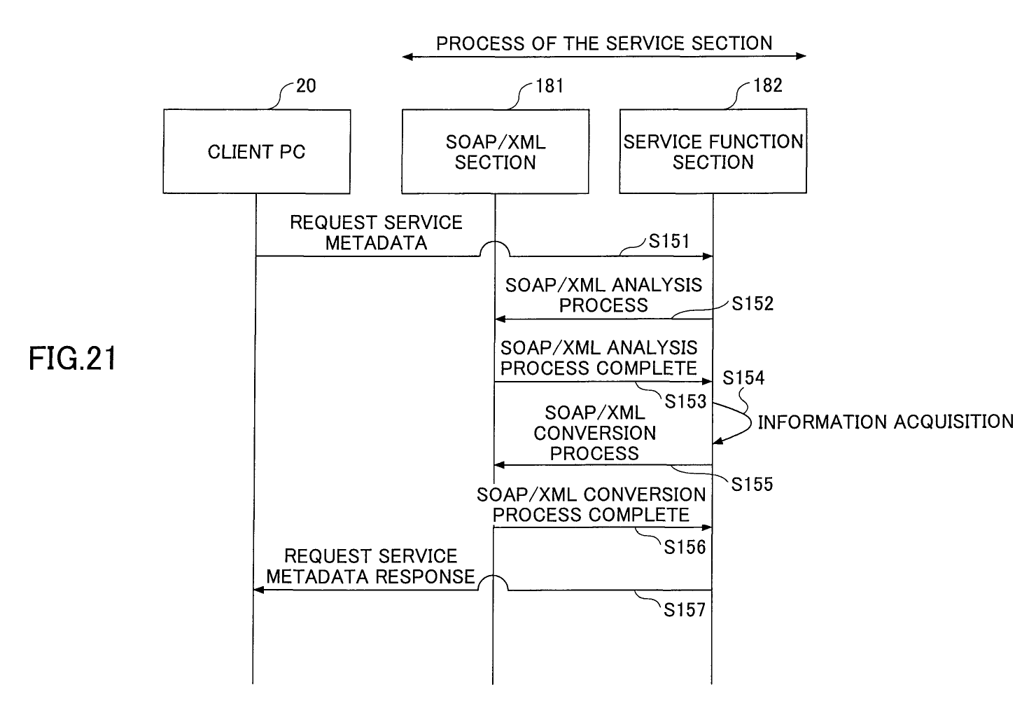

Shown in FIG. 21 is a sequence diagram illustrating the acquisition process of the basic information of a service. The process of FIG. 21 corresponds to step S112 of FIG. 10. After this stage, the component that communicates with the client PC 20 is the service section 180.

The client PC 20 sends a message that shows the acquisition request of the basic information of the service according to the specifications of the so called PrintServiceTemplate in response to the previously acquired URL that shows the providing location of the service (S151).

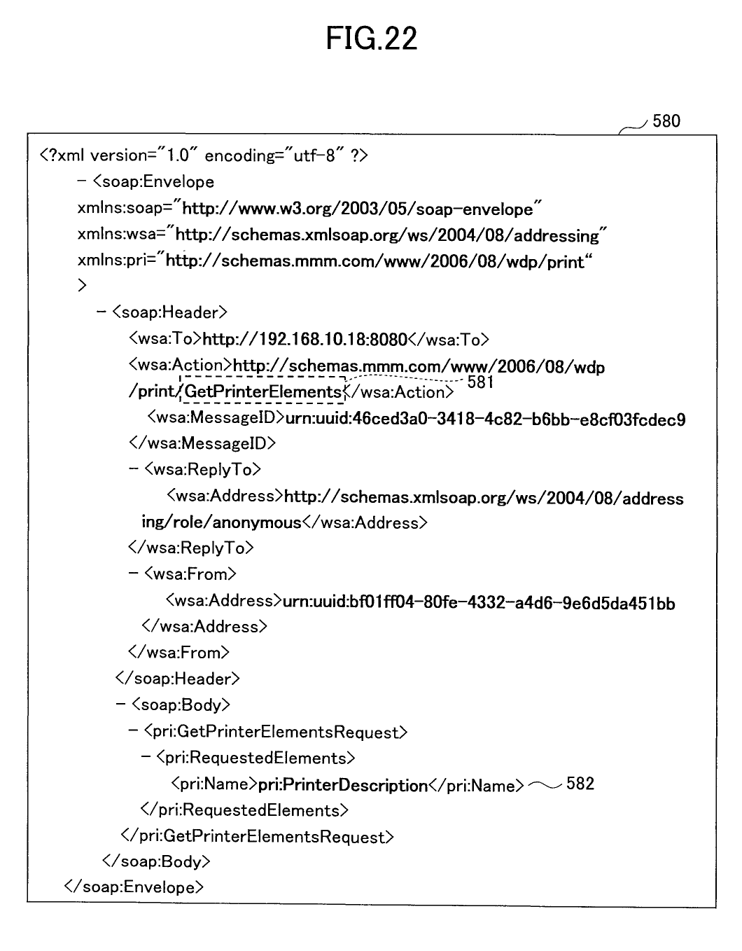

Shown in FIG. 22 is a message example illustrating the acquisition request for the basic information of a service. In the message 580 of FIG. 22 the “GetPrinterElements” description 581 identifies the message 580 as (GetPrinterElements message) requesting the acquisition of the basic information of the service. Also, the “pri:PrinterDescription” description 582 identifies the information targeted for acquisition.

In the multifunction machine 10, the service function section 182 that has received the message showing an acquisition request of the basic information has the SOAP/XML section 181 execute the deserialization of the corresponding message (S152, S153) and acquires the information targeted for acquisition (S154). Then the service function section 182 has the SOAP/XML section 181 execute the serialization of the acquired information (S155, S156) and according to the PrintServiceTemplate specifications returns a reply message including the information targeted for acquisition to the client PC 20 (S157).

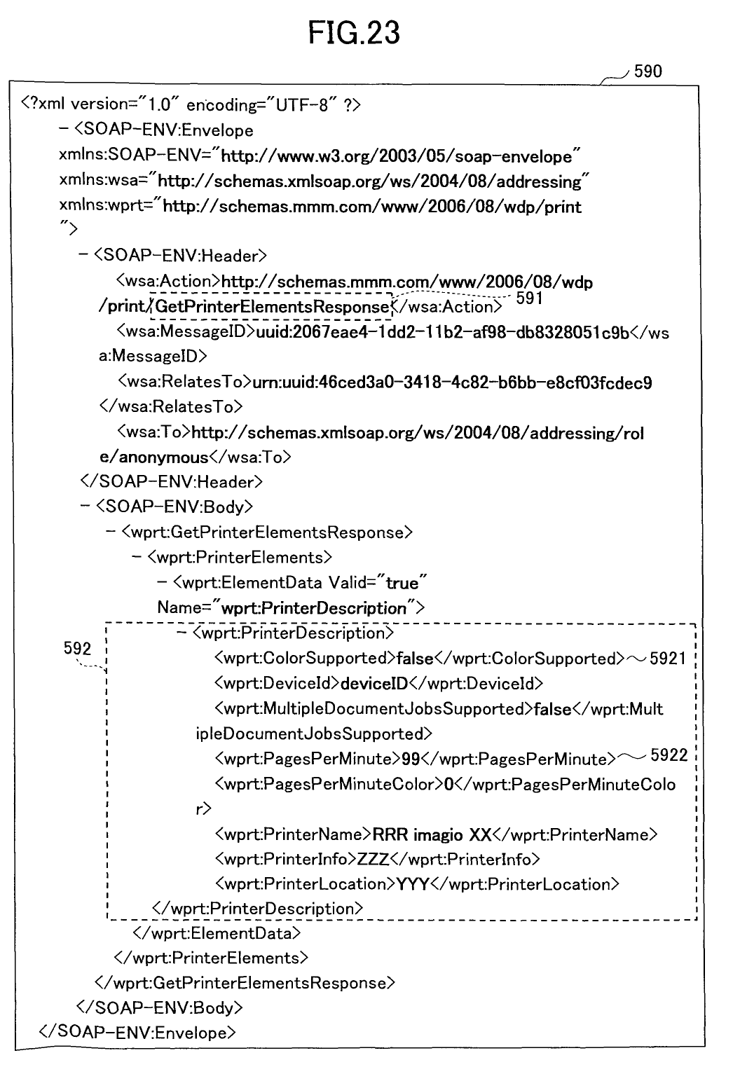

Shown in FIG. 23 is a reply message example to the acquisition request for the basic information of a service. In the message 590 of FIG. 23 is the “GetPrinterElementsResponse” description 591 that identifies the message 590 as a reply to the GetPrinterElements message. The information that is targeted for acquisition is described in the PrinterDescription Element 592. For example, in description 5921 the availability of color printing is confirmed. Also, in description 5922 the number of copies that can be printed per minute is given.

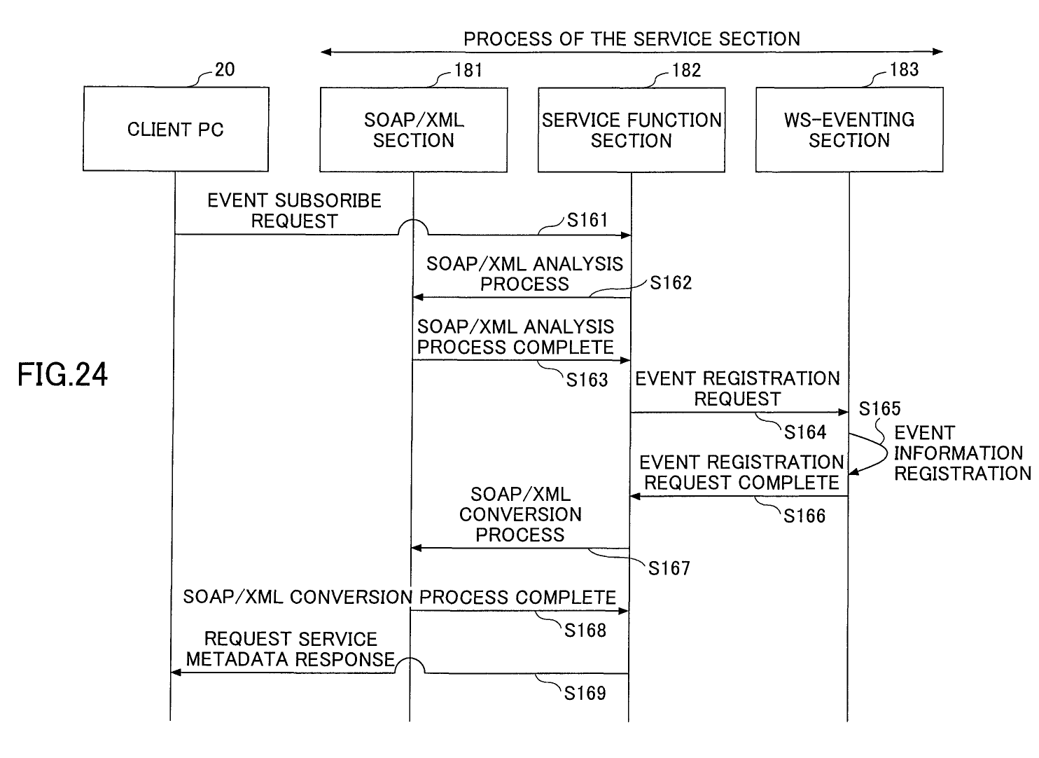

Shown in FIG. 24 is a sequence diagram illustrating the registration process of an event, which requests notification. The process of FIG. 24 corresponds to step S114 in FIG. 10.

The client PC 20 sends a Subscribe message that shows the request for a registration of an event, which requests notifying, according to the WS-Eventing specifications, the URL of the providing location of the service (S161).

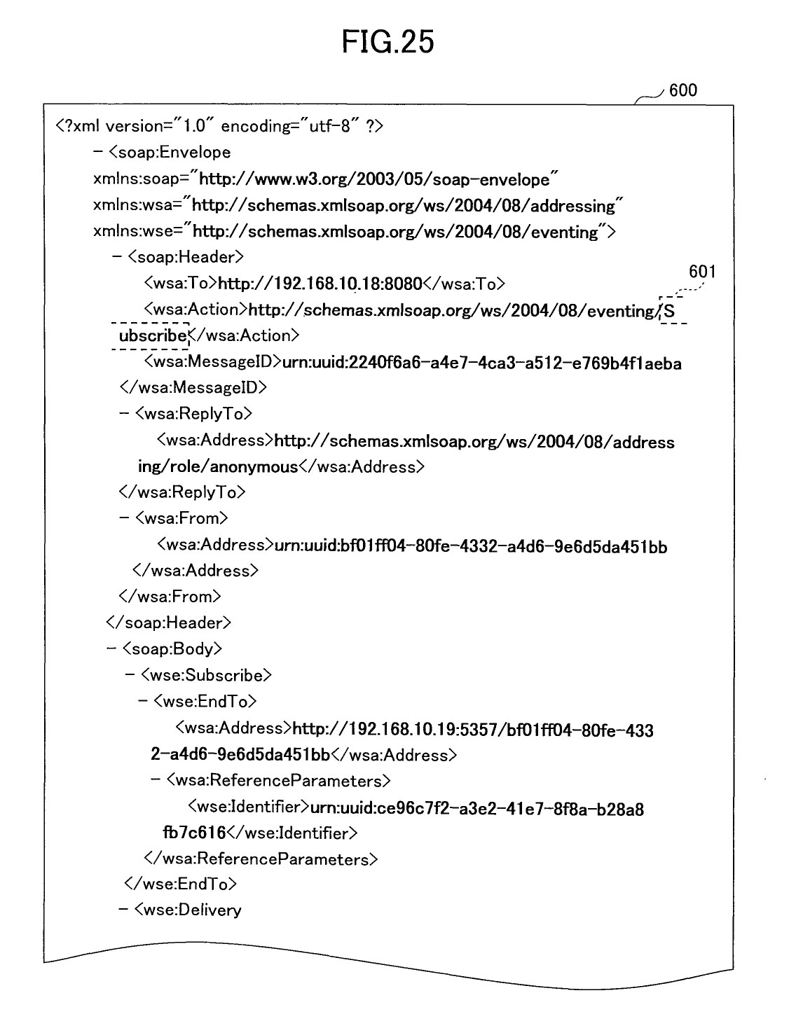

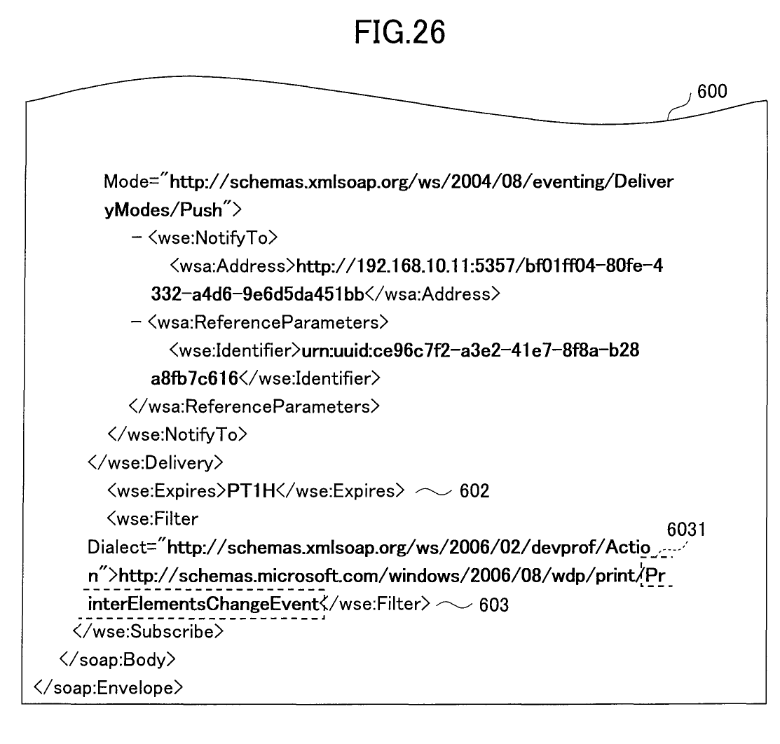

Shown in FIG. 25 and FIG. 26 are Subscribe message examples. In the message 600 of FIG. 25 and FIG. 26 the “Subscribe” description 601 identifies the message 600 as a subscribe message. Also, the valid duration (one hour) of registering the event is shown by the “PT1H” description 602. More specifically, there is a valid duration for registering the event and in principle after the duration expires the notifications of the event cannot be received. Though, if the client PC 20 requests for an extension of the duration for registering the event the client PC 20 may continue to receive the notifications of that event.

Also, in the description 603 the identification name of the event that request notification is given. Here the “PrinterElementsChangeEvent” (description 6031) that shows the change to printer status is specified.

In the multifunction machine 10, the service function section 182 that has received a message showing the request for event registration has the SOAP/XML section 181 execute the deserialization of the corresponding message (S162, S163) and send a request to the WS-Eventing section 183 for the registration of the event that requests notification (S164). The WS-Eventing section 183 registers (stores) the corresponding event as a notification target (S165) and reports the completion of event registration to the service function section 182 (S166).

Next, the service function section 182 has the SOAP/XML section 181 execute the serialization of the information showing the reply to the request for event registration (S167, S168) and according to the WS-Eventing specifications returns a reply message to the client PC 20 (S169).

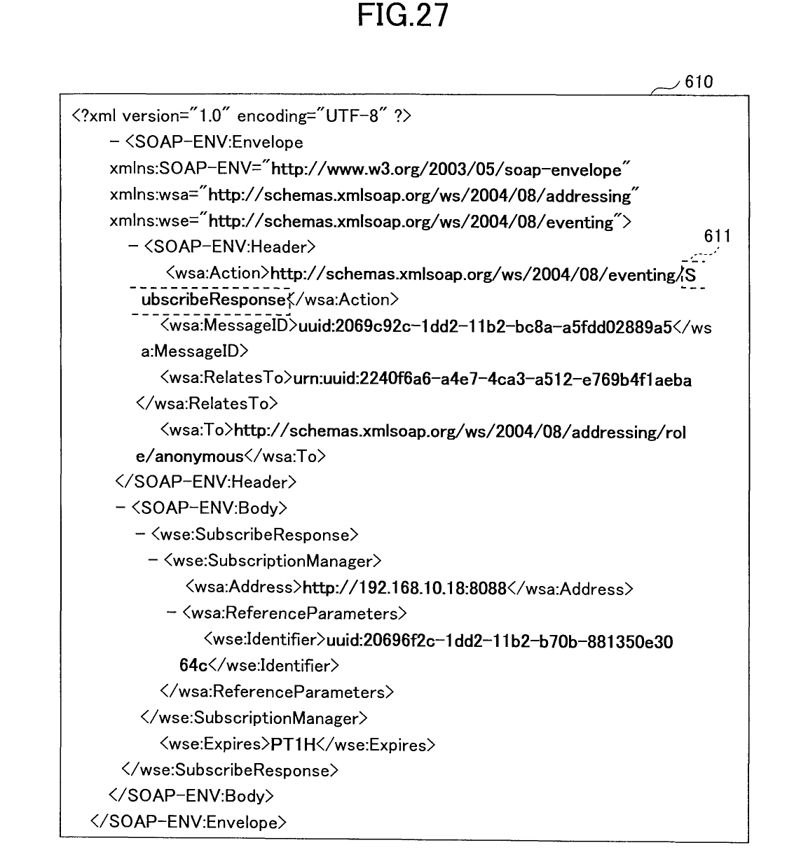

Shown in FIG. 27 is a reply message example to the request for event registration. In the message 610 of FIG. 27 the “SubscribeResponse” description 611 identifies the message 610 as a reply to the Subscribe message.

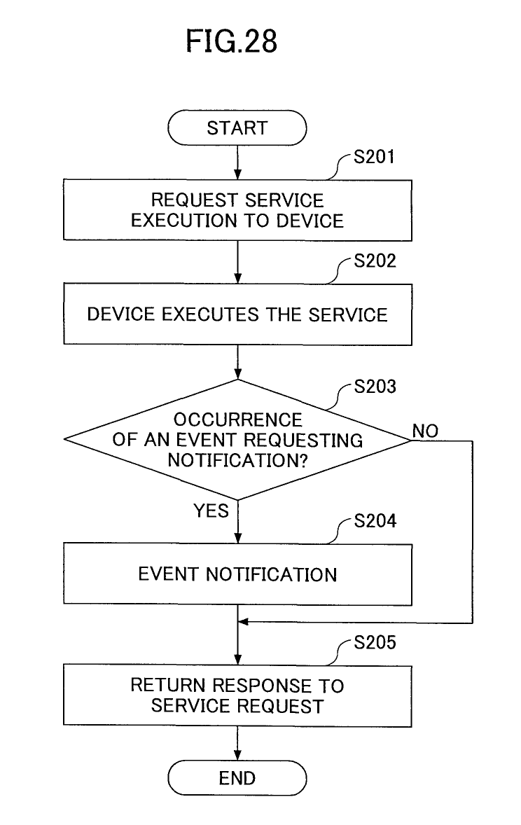

The following is an explanation of the process after pre-processing for the client PC 20 to receive the provided service. Shown in FIG. 28 is a flowchart illustrating an overview of the process upon service use. The process of FIG. 28 is executed after the process of FIG. 10.

In step S201, the client PC 20 sends a request for the execution of the service to the multifunction machine 10 that has executed the registration of the events in the above processes. According to the request by the client PC 20, the multifunction machine 10 executes the requested service (S202). If an event that requests notification (registered events) occurs during the execution of the service (Yes at S203) the multifunction machine 10 reports the corresponding event to the client PC 20 (S204). When the execution of the service is completed the multifunction machine 10 sends a reply to the service execution request to client PC 20 (S205). Note that after step S205 there is a possibility for a notification of an event (step S203 and S204).

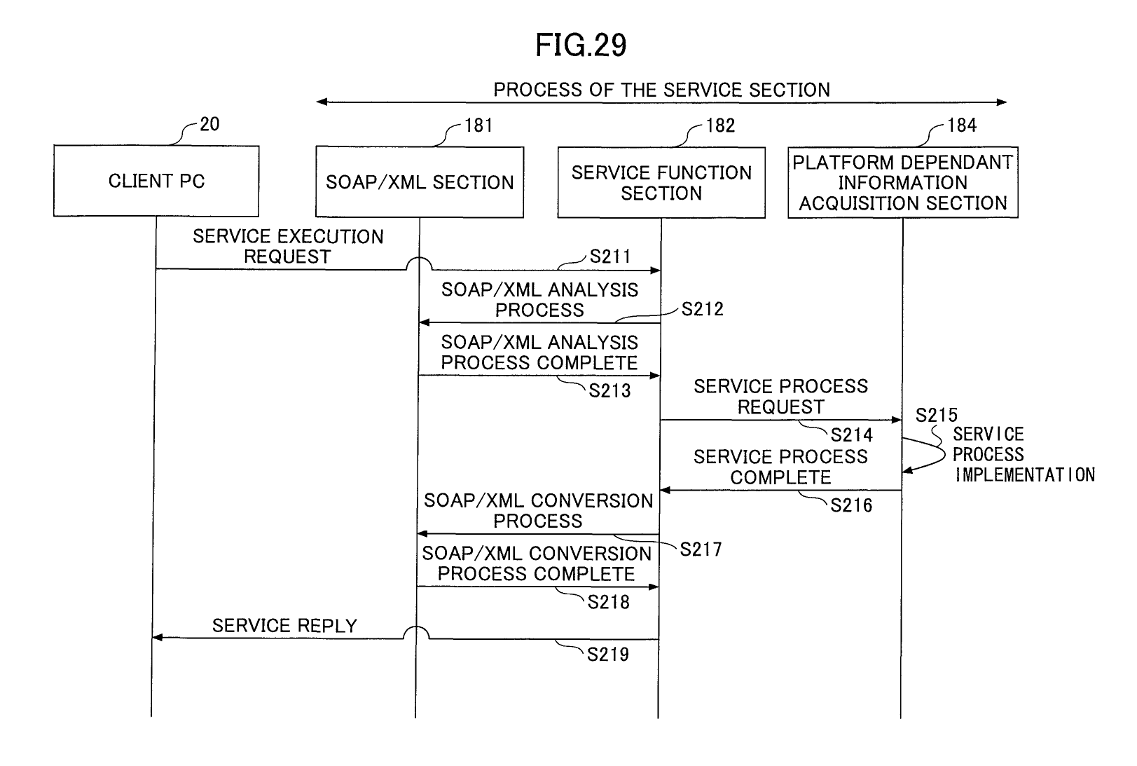

The following is an explanation of each step in detail. Shown in FIG. 29 is a sequence diagram illustrating the process upon service execution. The process of FIG. 29 corresponds to the steps S201, S202, and S205 of FIG. 28.

The client PC 20 sends a message showing a request for service execution to the URL that shows the providing location of the service (S211).

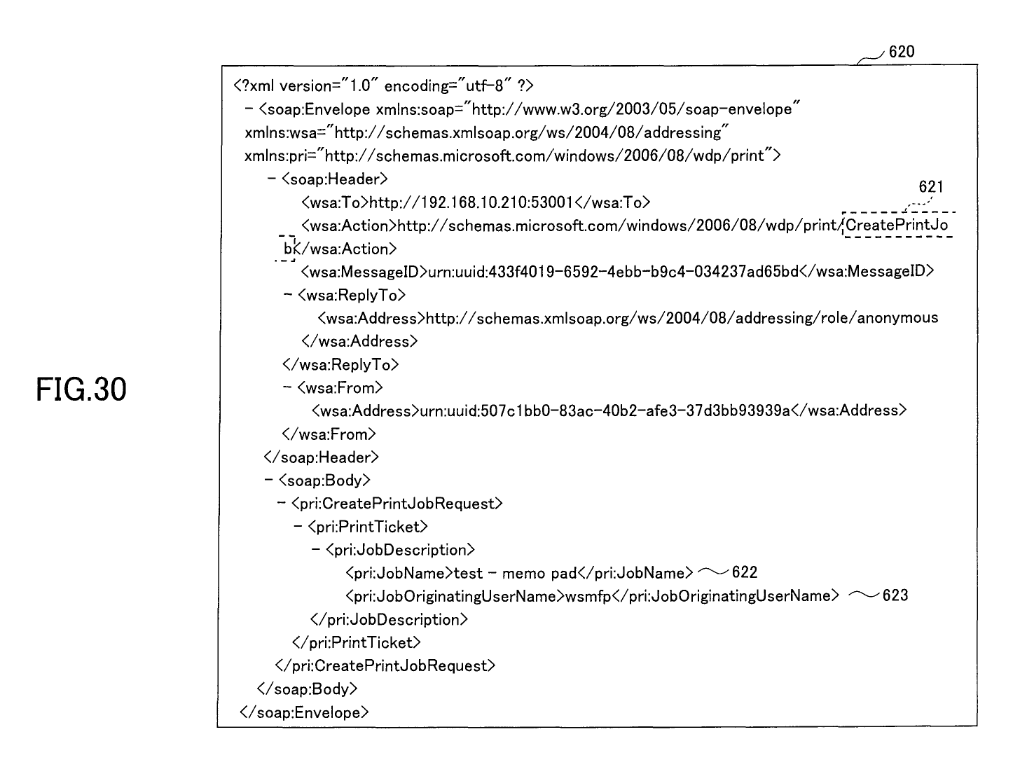

Shown in FIG. 30 is the first example of a message requesting service execution. In message 620 of FIG. 30 the “CreatePrintJob” description 621 identifies message 620 as a message that requests the creation of the print job. Also, in the description 622 the job name is specified and in the description 623 the user name that has requested the job is specified.

In the multifunction machine 10, the service function section 182 that has received the message requesting service execution has the SOAP/XML section 181 execute the deserialization of the corresponding message (S212, S213) and sends a request to the platform dependent information acquisition section 184 for the execution of the requested service (S214). At this conjuncture the parameters and such included in the message requesting service execution is reported to the platform dependent information acquisition section 184. The platform dependant information acquisition section 184 executes the requested service (S215) and when the execution is complete reports the completion to the service function section 182 (S216). At this conjuncture the information (for example, job ID) created as a result of the execution of the service is returned.

Next, the service function section 182 has the SOAP/XML section 181 execute the serialization of the information showing the reply to the request for service execution (S217, S218) and returns a reply message to the client PC 20 (S219).

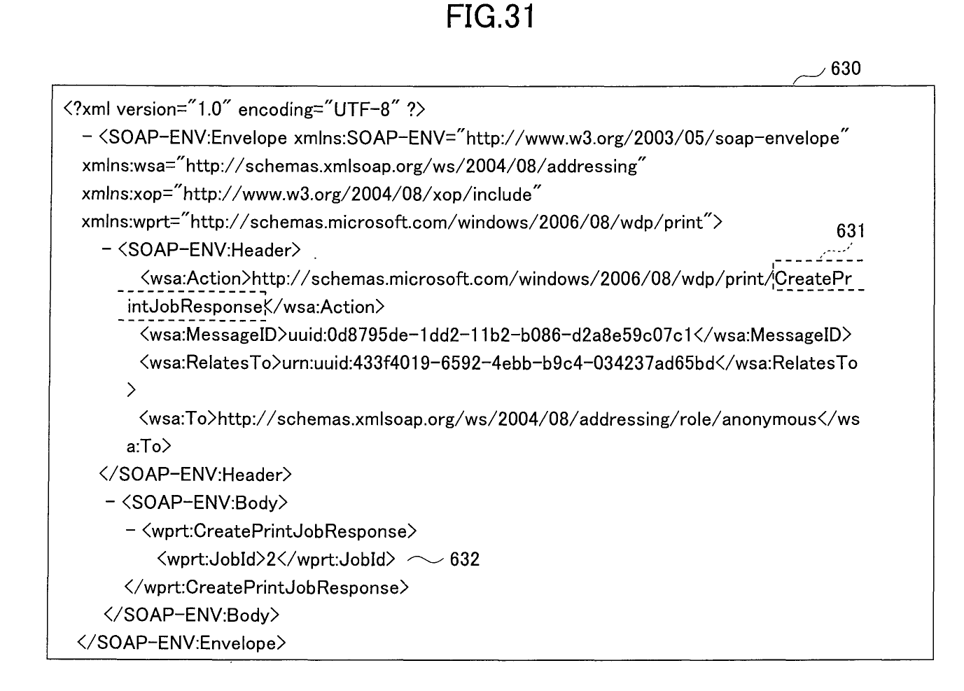

Shown in FIG. 31 is the first example of a reply message to the service execution request. In message 630 of FIG. 31 the “CreatePrintJobResponse” description 631 identifies the message 630 as a reply to the request for print job creation (CreatePrintJob). Also, in description 632 the job ID of the created print job is given.

Next, in the same way as steps S211˜S219, in the created print job, the document data that are the print target are sent from the client PC 20 (S211) and a reply to this is returned from the multifunction machine 10 (S219). Examples of the messages communicated in this transaction are shown in the following.

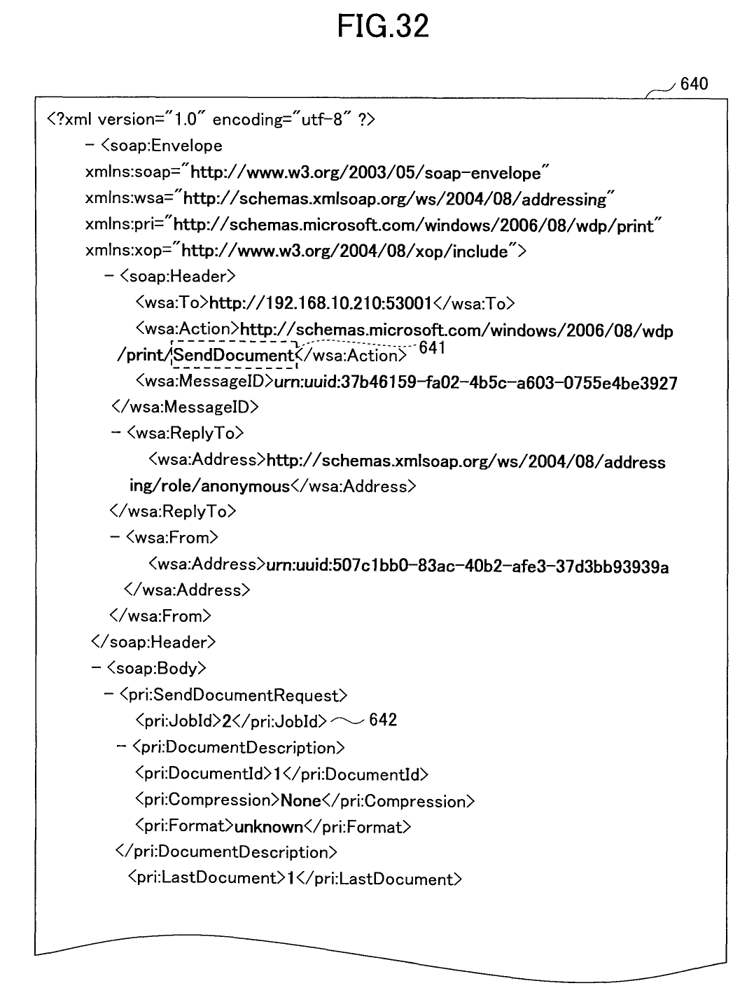

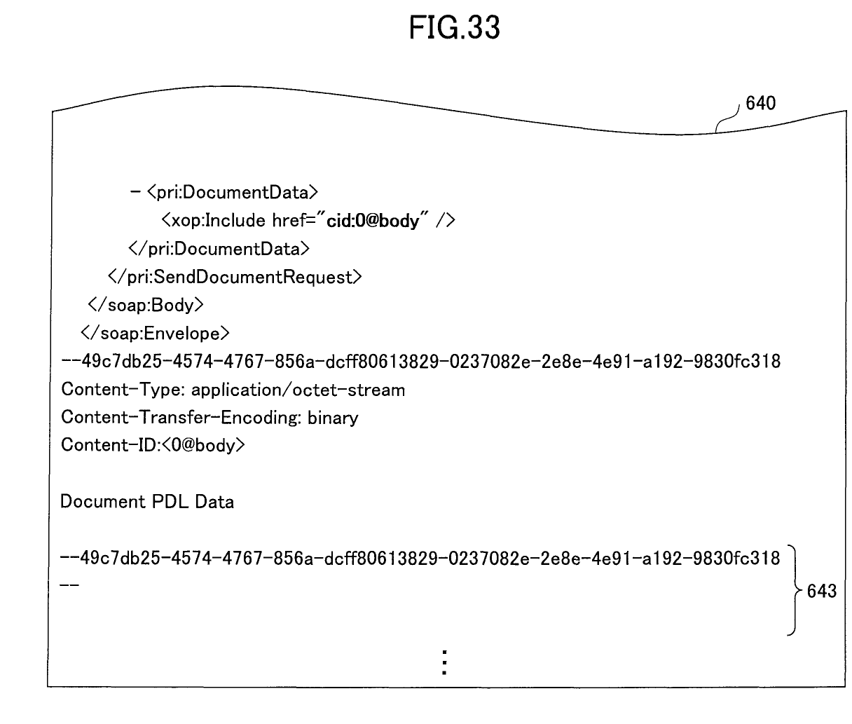

Shown in FIG. 32 and FIG. 33 are the second examples of a message requesting service execution. In the message 640 of FIG. 32 and FIG. 33 the “SendDocument” description 641 identifies message 640 as requesting the sending (printing) of the document data. Also, in the description 642 the job ID is specified and in the description 643 the encoded print data are included.

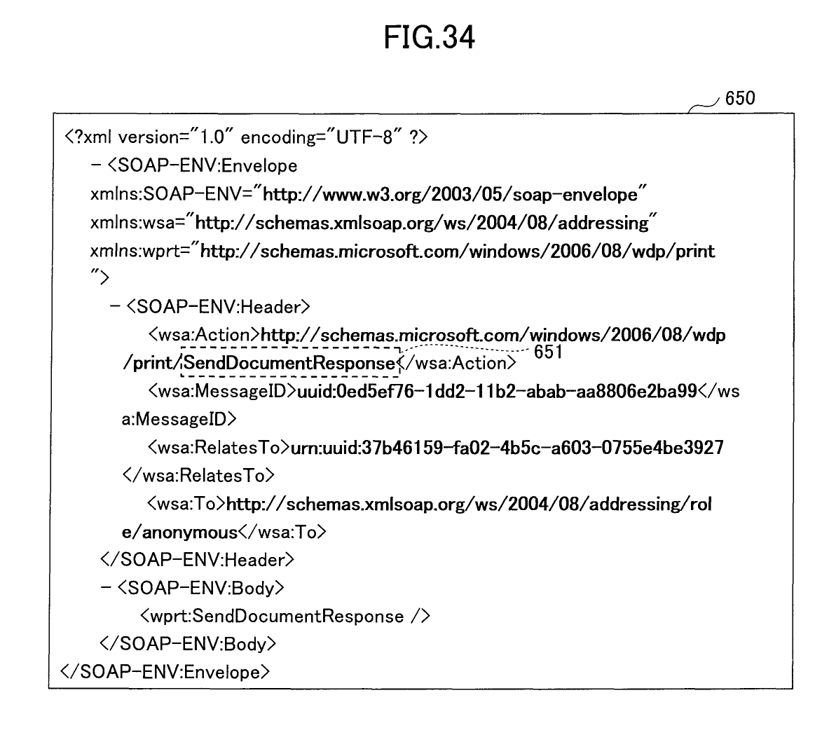

Shown in FIG. 34 is the second example of a reply message to the service execution request. In message 650 of FIG. 34 the “SendDocumentResponse” description 651 identifies the message 650 as a reply to the request for printing the document data (SendDocument).

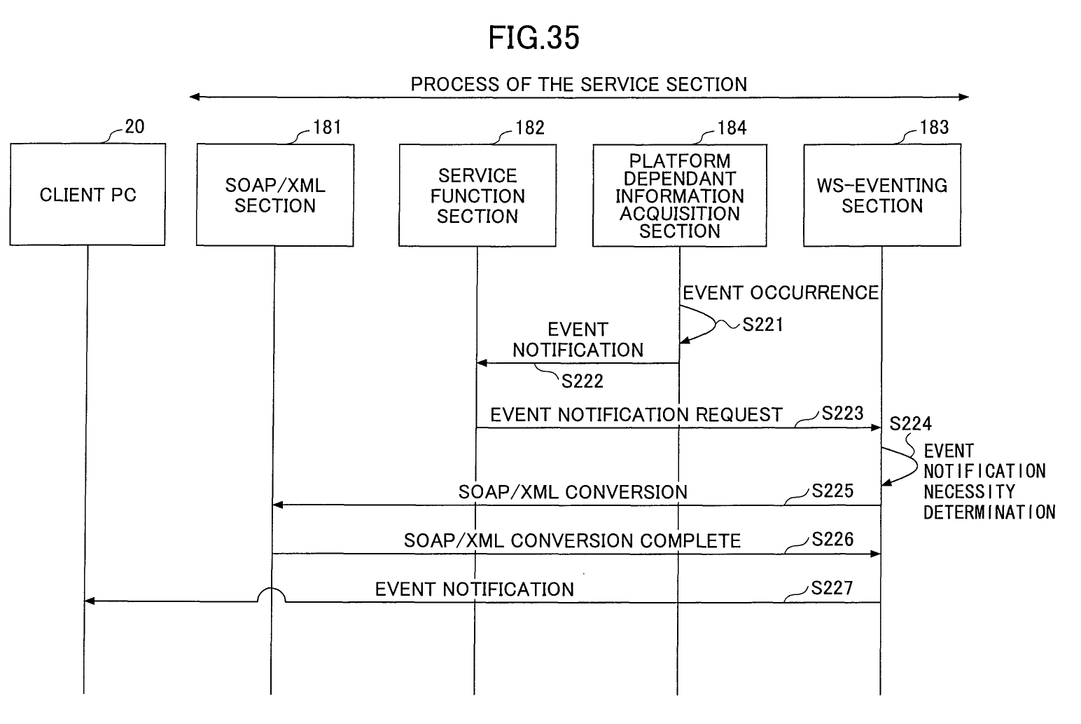

Shown in FIG. 35 is a sequence diagram illustrating the process procedure upon event occurrence. The process of FIG. 35 corresponds to the steps S203 and S204 of FIG. 28.

In the multifunction machine 10, when the platform dependant information acquisition section 184 detects an occurrence of an event (S221), it reports the occurrence of the event to the service function section 182 (S222). The service function section 182 sends a request to the WS-Eventing section 183 for notification to the client PC 20 of the event (S223). The WS-Eventing section 183 determines whether the corresponding event is registered as a notification target and determines whether there is a need to notify (S224). When there is a need to notify, the WS-Eventing section 183 has the SOAP/XML section 181 execute the serialization of the information showing the event (S225, S226) and according to the specifications of WS-Eventing sends a message reporting the event to client PC 20 (S227).

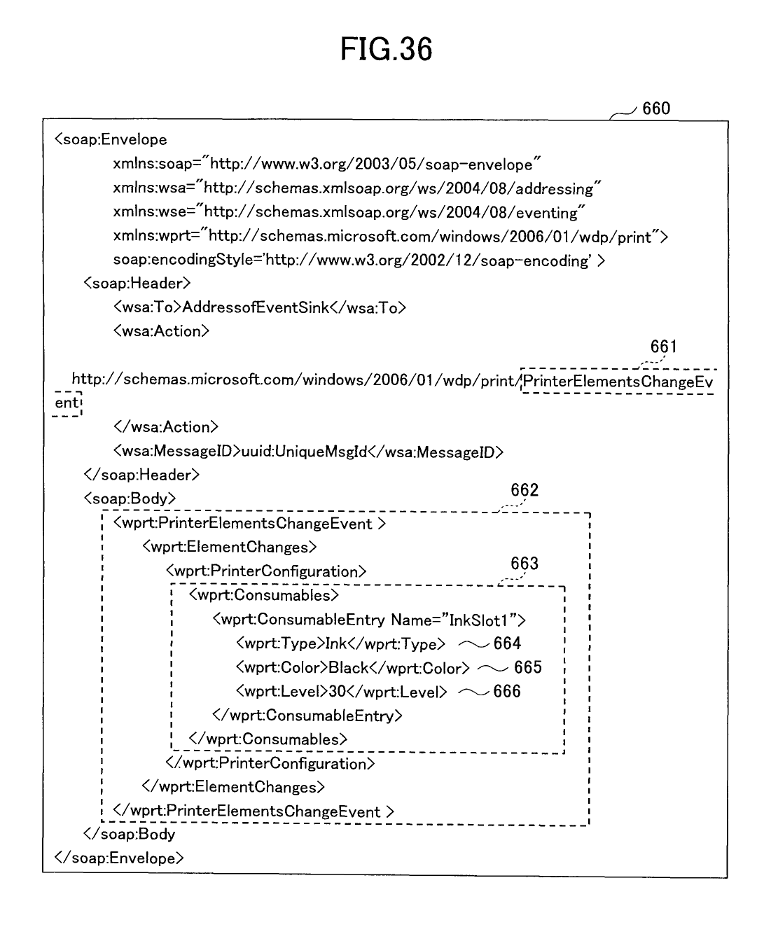

Shown in FIG. 36 is a message example reporting an event. In the message 660 of FIG. 36 the “PrinterElementsChangeEvent” description 661 identifies message 660 as a notification message of the PrinterElementsChangeEvent registered as a notification target. The details of the event are described within the PrinterElementsChangeEvent element 662. For example, the existence of the Consumables element 663 identifies the event as being an event that showing the decline in the remaining amount of consumable supplies. The description 664 identifies the type of the consumable supply as ink and the description 665 identifies the color of the ink as black. Also in description 666 the remaining amount of ink is shown.

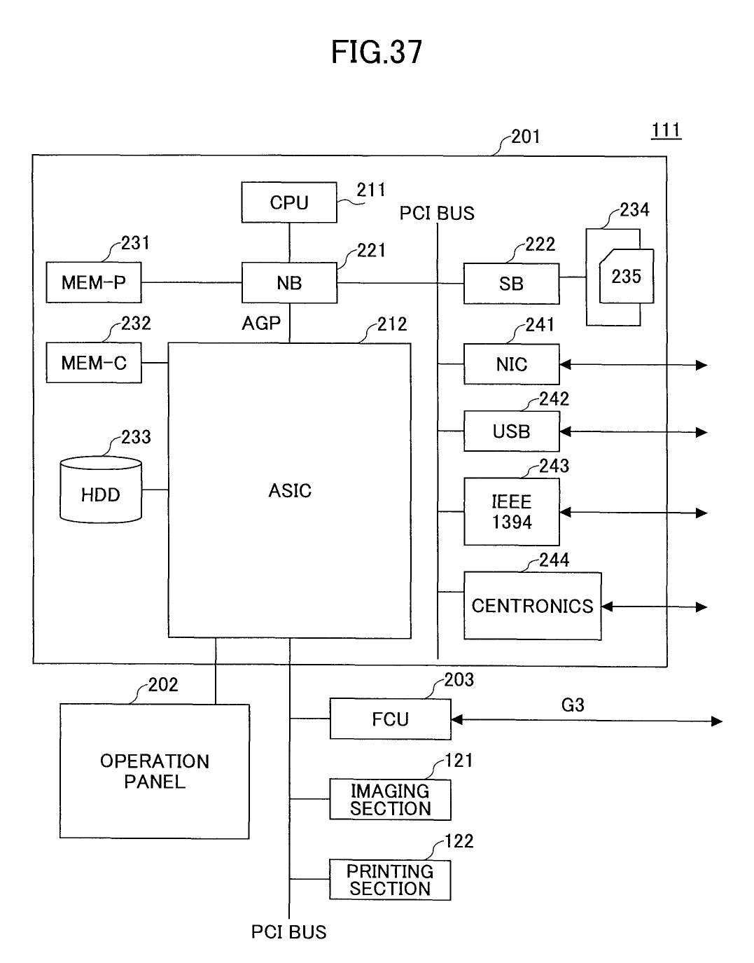

The following is an explanation of an example of the structure of the hardware 111 illustrated in FIG. 2. Shown in FIG. 37 is a schematic diagram illustrating the hardware structure of a multifunction machine according to an embodiment of the present invention. The hardware 111 of the multifunction machine 10 is comprised of a controller 201, an operations panel 202, a facsimile control unit (FCU) 203, an imaging unit 121, and a printing unit 122.

The controller 201 is comprised of a CPU 211, an ASIC 212, a NB 221, a SB 222, a MEM-P 231, a MEM-C 232, a HDD (hard disk drive) 233, a memory card slot 234, a NIC (network interface controller) 241, an USB device 242, an IEEE 1394 device 243, and a centronics device 244.

The CPU 211 is the IC for processing information. The ASIC 212 is the IC for processing various images. The NB 221 is the north bridge of the controller 201. The SB 222 is the south bridge of the controller 201. The MEM-P 231 is the system memory of the multifunction machine 10. The MEM-C 232 is the local memory of the multifunction machine 10. The HDD 233 is the storage of the multifunction machine 10. The memory card slot 234 is the slot for the memory card 235. The NIC 241 is the controller for network communication by the MAC address. The USB device 242 is the device providing the connection terminal of USB standards. The IEEE 1394 device 243 is the device providing the connection terminal of IEEE 1394 standards. The Centronics device 244 is the device providing the connection terminal of Centronics standards.

The operations panel 202 is the hardware (control section) for input into the multifunction machine 10 by the operator and the hardware (display section) to acquire output from the multifunction machine 10 for the operator.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

This patent application is based on Japanese Priority Patent Application No. 2007-240086 filed on Sep. 14, 2007, the entire contents of which are hereby incorporated herein by reference.

What is claimed is:

1. A network device providing a service to a client device connected via a network, comprising:
an information providing section to provide information that promotes accessing said service by said client device; and
a service execution section to execute a requested service according to a request from said client device based upon the information provided by said information providing section,
wherein said information providing section and said service execution section are booted as separate processes.

2. The network device of claim 1, wherein there is a corresponding one of said service execution sections for each type of said service, and said corresponding service execution section is booted as a process for each service.

3. The network device of claim 1, wherein said information providing section includes a first section that according to a search request for one of the services from said client device determines the existence of the one service targeted for search and according to the determination results returns identification information to access the service to said client device, and a second section that according to the information returned by said first section and according to the request sent from said client device returns information pertaining to the network device; said service execution section includes a third section that according to the request from said client device based upon said identification information executes the requested service, and a fourth section that notifies said client device of an occurrence of an event according to the execution of the requested service.

4. The network device of claim 3, wherein said first section and said second section included in said information providing section and said third section and said fourth section included in said service execution section are booted as separate threads.

5. The network device of claim 1, wherein upon booting the process of said service execution section, said information providing section is notified of the potential to provide a service, and said information providing section according to the notification from said service execution section announces via the network the potential to provide the service.

6. The network device of claim 1, wherein said service execution section reports the termination of a provided service to said information providing section upon the termination of the processes, and said information providing section according to the report from said service execution section reports via the network the termination of providing said service.

7. A service providing method that is executed by a network device to provide a service to a client device connected via a network, comprising:
an information providing procedure to provide information that promotes accessing said service by said client device; and
a service execution procedure to execute a requested service according to a request from said client device based upon the information provided by said information providing procedure,
wherein said information providing procedure and said service execution procedure are booted as separate processes.

8. The service providing method of claim 7, wherein there is a corresponding one of said service execution procedures for each type of said service and said corresponding service execution procedure is booted as a process for each service.

9. The service providing method of claim 7, wherein said information providing procedure includes a first procedure that according to a search request for one of the services from said client device determines the existence of the one service targeted for search and according to the determination results returns identification information to access the service to said client device, and a second procedure that according to the information returned by said first procedure and according to the request sent from said client device returns information pertaining to the network device; wherein said service execution procedure includes a third procedure that according to the request from said client device based upon said identification information executes the requested service, and a fourth procedure that notifies said client device of an occurrence of an event according to the execution of the requested service.

10. The service providing method of claim 9, wherein said first procedure and second procedure included in said information providing procedure and said third procedure and fourth procedure included in said service execution procedure are booted as separate threads.

11. The service providing method of claim 7, wherein upon booting the process of said service execution procedure, the process of said information providing procedure is notified of the potential to provide a service, and the process of said information providing procedure according to the notification from the process of said service execution procedure announces via the network the potential to provide the service.

12. The service providing method of claim 7, wherein upon the termination of the process of said service execution procedure the termination of a provided service is reported to the process of said information providing procedure, and the process of said information providing procedure according to the report from the process of said service execution procedure reports via the network the termination of providing said service.

13. A computer-readable recording medium comprising a service providing program by which computer network devices execute a service providing method that is executed by a network device to provide a service to a client device connected via a network, comprising:
an information providing procedure to provide information that promotes accessing said service by said client device; and
a service execution procedure to execute a requested service according to a request from said client device based upon the information provided by said information providing procedure,
wherein said information providing procedure and said service execution procedure are booted as separate processes.
